(19) United States
(12) Patent Application Publication
(10) Pub. No.: US 2022/0198399 A1
(43) Pub. Date: Jun. 23, 2022

(54) CONVERSATIONAL RECRUITING SYSTEM

(71) Applicant: LIVEPERSON, INC., New York, NY (US)

(72) Inventors: Dev Sharma, New York, NY (US); Marco Ambrosio, New York, NY (US); Sam Kirby, New York, NY (US)

(73) Assignee: LIVEPERSON, INC., New York, NY (US)

(21) Appl. No.: 17/556,331

(22) Filed: Dec. 20, 2021

Related U.S. Application Data
(60) Provisional application No. 63/128,301, filed on Dec. 21, 2020.

(51) Int. Cl. G06Q 10/10

(52) U.S. Cl. CPC G06Q 10/1053; H04L 51/02

(57) ABSTRACT

Disclosed embodiments provide a framework to facilitate recruitment and processing of applicants. A bot recruiting agent is implemented that engages in a communications session with applicants to solicit responses to questions for a job opening. The responses are scored according to a set of metrics and a fitness score for each applicant is provided. Based on the fitness score, a recommendation for advancing an applicant for the job opening is generated.

### CROSS-REFERENCE TO RELATED APPLICATIONS

The present patent application claims the priority benefit of U.S. provisional patent application No. 63/128,301 filed Dec. 21, 2020, the disclosures of which are incorporated by reference herein.

### FIELD

The present disclosure relates generally to systems and methods for facilitating recruitment and processing of applicants. More specifically, techniques are provided to deploy a framework to assist hiring managers in identifying applicants for job openings using automated bot agents.

### SUMMARY

Disclosed embodiments provide a framework to generate and implement automated bot agents that can interact with applicants in real-time and generate grades and scores that can be used to identify applicants for job openings or requisitions. According to some embodiments, a computer-implemented method is provided. The computer-implemented method comprises receiving a requisition. The requisition includes a set of questions to be presented to one or more applicants. The set of questions correspond to a set of metrics for evaluating responses to the set of questions. The computer-implemented method further comprises generating an automated bot based on the requisition. The automated bot is generated to communicate with the one or more applicants over a communications session. The computer-implemented method further comprises presenting the set of questions using the automated bot. Further, the computer-implemented method comprises receiving one or more responses to the set of questions. The computer-implemented method further comprises automatically calculating a fitness of the one or more responses. The one or more responses correspond to the one or more applicants. Further, the fitness of the one or more responses is calculated based on desired responses to the set of questions and the set of metrics. The computer-implemented method further comprises determining a fitness of the one or more applicants based on the fitness of the one or more responses. The computer-implemented method further comprises generating recommendations for modifying the set of metrics based on the fitness of the one or more responses.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The present disclosure is described in conjunction with the appended Figures:

FIG. 1 shows an illustrative example of an environment in which a recruiting automation service executes one or more bot recruiting agents to automatically engage with applicants to obtain information usable to grade the applicants for one or more job openings or requisitions in accordance with at least one embodiment;

FIGS. 2A-2D show an illustrative example of an interface provided via a service dashboard that can be used to generate a new job opening or requisition and define parameters for configuration of a bot recruiting agent for the new job opening or requisition in accordance with at least one embodiment;

FIG. 3 shows an illustrative example of an environment in which a bot recruiting agent engages in a communications session with an applicant to solicit and obtain responses from the applicant for a job opening or requisition in accordance with at least one embodiment;

FIG. 4 shows an illustrative example of an environment in which a hiring manager is provided with applicant grades and the status of a job opening or requisition via a user interface in accordance with at least one embodiment;

FIG. 5 shows an illustrative example of an interface provided via a service dashboard for evaluation of applicant grades, provided materials, and metrics associated with a job opening or requisition in accordance with at least one embodiment;

FIG. 6 shows an illustrative example of an interface provided via a service dashboard for reviewing recommendations and adjusting metrics corresponding to questions provided to applicants via a bot recruiting agent for a job opening or requisition in accordance with at least one embodiment;

FIG. 7 shows an illustrative example of a process for configuring a bot recruiting agent for a new job opening or requisition in accordance with at least one embodiment;

FIG. 8 shows an illustrative example of a process for grading responses provided by an applicant based on interaction with the applicant via a communications session and provided the grades and other provided materials for an applicant in accordance with at least one embodiment;

FIG. 9 shows an illustrative example of a process for generating recommendations for changing metrics associated with questions provided to applicants based on fitness of previously provided responses from applicants in accordance with at least one embodiment; and

FIG. 10 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred examples of embodiment(s) only and is not intended to limit the scope, applicability or configuration of the disclosure. Rather, the ensuing description of the preferred examples of embodiment(s) will provide those skilled in the art with an enabling description for implementing a preferred examples of embodiment. It is understood that various changes can be made in the function and arrangement of elements without departing from the spirit and scope as set forth in the appended claims.

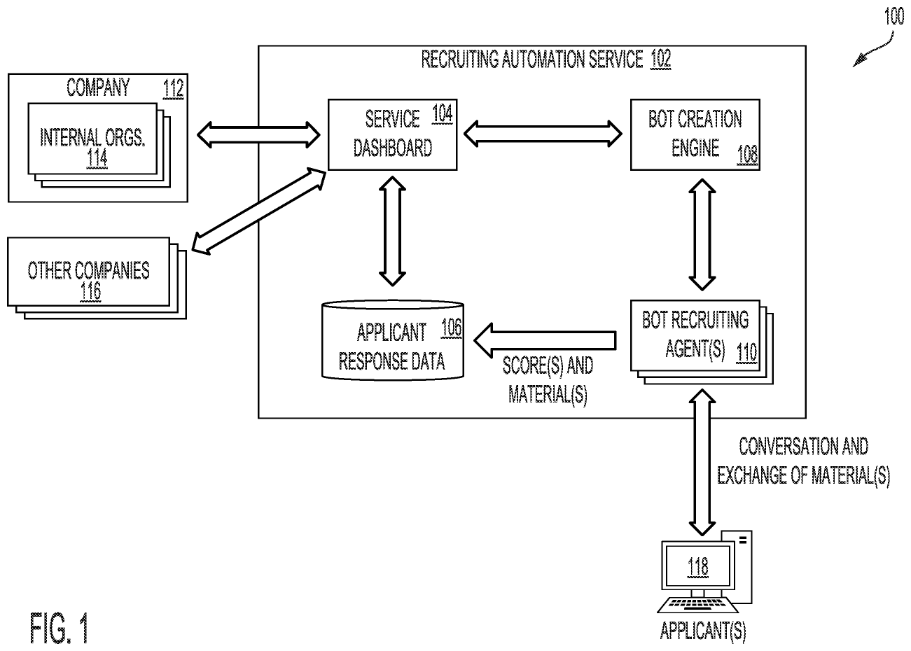

FIG. 1 shows an illustrative example of an environment 100 in which a recruiting automation service 102 executes one or more bot recruiting agents 110 to automatically engage with applicants 118 to obtain information usable to grade the applicants 118 for one or more job openings or requisitions in accordance with at least one embodiment. In the environment 100, a company 112, via a service dashboard 104 of a recruiting automation service 102, transmits a request to the recruiting automation service 102 to solicit applications for a new job opening or requisition. The company 112 may include one or more internal organizations 114 (e.g., different company sites, business units, teams, etc.) that may have different openings for which qualified applicants are desired. Thus, the company 112 may use the service dashboard 104 of the recruiting automation service 102 to request solicitation of applications for new job openings or requisitions corresponding to one or more of these internal organizations 114. In an embodiment, the service dashboard 104 of the recruiting automation service 102 can also be made available to other companies 116 that are distinct from the company 112 and its internal organizations 114. These other companies 116 can submit requests to solicit applications for new job openings or requisitions for their respective internal organizations. Thus, the recruiting automation service 102 may manage job openings or requisitions for different companies and corresponding internal organizations.

The recruiting automation service 102, via the service dashboard 104, may provide a platform for companies to generate and manage job openings or requisitions that may be made available to potential applicants 118. The service dashboard 104 may be implemented on a computer system or other system (e.g., server, virtual machine instance, etc.) of the recruiting automation service 102. Alternatively, the service dashboard 104 may be implemented as an application or other process executed on a computing system of the recruiting automation service 102. In an embodiment, the service dashboard 104 may provide to hiring managers or other entities associated with the company 112 responsible for hiring personnel for open job positions or requisitions an interface through which the hiring managers or other entities may define the parameters of a new job opening or requisition that is to be posted by the recruiting automation service 102 for potential applicants 118. For instance, via this interface, a hiring manager may provide a name for the job opening or requisition, as well as information corresponding to the internal organization for which an applicant is to be identified. Additionally, via the interface, a hiring manager may determine what questions are to be provided to potential applicants 118 in order to determine the fitness of these potential applicants 118 for the job opening or requisition. For example, the hiring manager may select, via the interface, questions related to an applicant's work experience, project experience, club experience, education, technical expertise, hobbies, interests, traits, and the like.

In an embodiment, the recruiting automation service 102 provides, via the service dashboard 104 and corresponding interface, various tools to indicate the level of importance for each of the questions that are to be provided to potential applicants 118 for a particular job opening or requisition. For instance, as described in greater detail herein, the recruiting automation service 102 may provide, via the service dashboard 104 and for one or more questions, a slider or other selection tool that may be used to indicate the level of importance for each of the one or more questions. Based on the level of importance assigned to each question by a hiring manager or other entity, the recruiting automation service 102 may determine a weight for each of these questions. For example, if a hiring manager or other entity indicates that work experience is of paramount importance for the job opening or requisition, the recruiting automation service 102 may assign a greater weight to questions related to work experience. Alternatively, if a hiring manager or other entity indicates that work experience is less important for the job opening or requisition, the recruiting automation service 102 may assign a lower weight to questions related to work experience. In an embodiment, these weights may be used to determine an overall score (e.g., grade, etc.) for an applicant 118 applying for the job opening or requisition via the recruiting automation service 102. As an illustrative example, if a hiring manager or other entity indicates that work experience is of paramount importance, an applicant 118 having work experience that closely matches the requirements of the job opening or requisition, as defined by the hiring manager or other entity, may be assigned a higher score compared to another applicant without similar work experience but that otherwise may satisfy other requirements of the job opening or requisition that are not as important.

Information corresponding to a newly created job opening or requisition may be stored within an applicant response data store 106. The applicant response data store 106 may be implemented using a not only structured query language (NoSQL) database, through which information and data corresponding to the newly created job opening or requisition may be stored and used for analysis and data processing by the recruiting automation service 102. It should be noted that while the applicant response data store 106 is described as being implemented as a NoSQL database, the applicant response data store 106 may be implemented using any available data structure that allows for storage and association of data and information associated with job openings and requisitions created via the service dashboard 104.

In an embodiment, the service dashboard 104 provides the parameters (e.g., selected questions and corresponding weights assigned by a hiring manager or other entity, etc.) of a new job opening or requisition to a bot creation engine 108 for creation of a bot recruiting agent 110 associated with the new job opening or requisition. These parameters may be provided in the form of executable instructions that may be executed via a web application or other application that implements a bot recruiting agent 110 for the particular job opening or requisition. In some implementations, bot recruiting agents 110 can be configured to autonomously chat with applicants 118 for corresponding job openings or requisitions. Further, the bot recruiting agents 110 can be configured to perform additional functions for corresponding job openings or requisitions. For instance, in an embodiment, the bot creation engine 108 can configure a bot recruiting agent 110 to automatically calculate each applicant's grade or other score based on evaluation of responses and materials provided by an applicant 118 during a communications session between the applicant 118 and the bot recruiting agent 110.

The bot creation engine 108 may be implemented on a computer system or other system (e.g., server, virtual machine instance, etc.) of the recruiting automation service 102. Alternatively, the bot creation engine 108 may be implemented as an application or other process executed on a computing system of the recruiting automation service 102. In an embodiment, the bot creation engine 108 hosts a native conversational application that is configured to use bot recruiting agents 110 to communicate with applicants 118 and dynamically update content as applicants 118 provide responses to questions provided by the bot recruiting agents 110 via communications sessions between the bot recruiting agents 110 and the applicants 118. In some embodiments, the recruiting automation service 102 maintains a web server (not shown) that hosts a website configured to present or otherwise make available job openings or requisitions posted by any of the companies 112, 116. For instance, via the website, an applicant 118 may submit a query to identify any job openings or requisitions that the applicant 118 may be interested in. As an example, if an applicant 118 submits a query to identify job openings or requisitions for a particular company in a particular location, the recruiting automation service 102 may query the applicant response data store 106 to identify the job openings or requisitions corresponding to the applicant's query. These job openings or requisitions may be presented to the applicant 118 via the website.

In an embodiment, the recruiting automation service 102 implements a bot to communicate with applicants 118 to identify job openings or requisitions that may be of interest to the applicants 118. For instance, when an applicant 118 visits the website implemented by the recruiting automation service 102, the recruiting automation service 102 may execute a bot or other automated process to communicate with the applicant 118 and elicit, from the applicant 118, responses that may be used to identify job openings or requisitions that may be of interest to the applicant 118. For instance, when an applicant 118 accesses the website provided by the recruiting automation service 102, the bot or other automated process may communicate with the applicant 118 and ask the applicant 118 different questions related to its job opening or requisition search. As an illustrative example, the bot may prompt the applicant 118 to provide information related to the applicant's technical experience, work experience, education, hobbies, and the like.

In an embodiment, the bot can use a machine learning algorithm or artificial intelligence to process the applicant's responses in order to identify and extract information that may be used to identify job openings or requisitions that may be of interest to the applicant 118. The machine learning algorithm may be used to perform a semantic analysis of the responses (e.g., by identifying keywords, sentence structures, repeated words, punctuation characters and/or non-article words) to identify the information in the responses that may be used to identify relevant job openings or requisitions. The machine learning algorithm utilized by the bot may be dynamically trained using supervised learning techniques. For instance, a dataset of input responses and known relevant job openings or requisitions corresponding to the input responses can be selected for training of the machine learning algorithm. In some implementations, known relevant job openings or requisitions used to train the machine learning algorithm may include characteristics of these job openings or requisitions. The machine learning algorithm may be evaluated to determine, based on the input sample responses supplied to the machine learning algorithm, whether the machine learning algorithm is identifying the expected job openings or requisitions based on the responses. Based on this evaluation, the machine learning algorithm may be modified to increase the likelihood of the machine learning algorithm generating the desired results. The machine learning algorithm may further be dynamically trained by soliciting feedback from applicants 118 with regard to the recommended job openings or requisitions obtained based on submitted responses. For instance, the recruiting automation service 102 may record interaction with presented job openings or requisitions by an applicant 118 to determine whether the presented job openings or requisitions correspond to the responses submitted by the applicant 118. The applicant interactions may, thus, be utilized to train the machine learning algorithm based on the accuracy of the machine learning algorithm in identifying relevant job openings or requisitions.

In an embodiment, when an applicant 118 selects a particular job opening or requisition from the website, the bot creation engine 108 executes the native conversational application for the particular job opening or requisition. Through the native conversational application, the bot creation engine 108 may initiate a bot recruiting agent 110 for the job opening or requisition. As noted above, a particular bot recruiting agent 110 may be configured based on the parameters for its corresponding job opening or requisition. For instance, the bot recruiting agent 110 may be configured to solicit responses to questions submitted by a hiring manager that generated the job opening or requisition via the service dashboard 104. In an embodiment, the bot recruiting agent 110 uses natural language processing (NLP) or other artificial intelligence to query the applicant 118 for responses that can be used to determine the applicant's fitness (e.g., grade, score, etc.) for the particular job opening or requisition. Responses provided by the applicant 118 to the bot recruiting agent 110 may be evaluated by the bot recruiting agent 110 according to the grading schema provided by the bot creation engine 108 and configured based on the weights assigned to each of the corresponding questions by the hiring manager or other entity that submitted the job opening or requisition.

In an embodiment, the bot recruiting agent 110 can also solicit, from an applicant 118, additional materials that can be used to determine the fitness of the applicant 118 for the corresponding job opening or requisition. For instance, the bot recruiting agent 110 may prompt an applicant 118 to provide its resume or curriculum vitae, any hyperlinks to professional profiles or websites, any sample works prepared by the applicant 118, and the like. In an embodiment, the bot recruiting agent 110 can evaluate any provided materials to identify any elements that may be used to grade or score the applicant 118 according to the applicant's fitness for the particular job opening or requisition. For instance, if the applicant 118 provides its resume or curriculum vitae, the bot recruiting agent 110 may process the resume or curriculum vitae to identify any information that may serve as responses to questions submitted by the hiring manager or other entity that submitted the job opening or requisition or as additional information that can be used to supplement responses to these questions.

In an embodiment, the bot recruiting agent 110 may process the responses provided by the applicant 118, as well as any additional materials provided by the applicant 118, to calculate a fitness grade or other score of the applicant 118 for the job opening or requisition. As noted above, a hiring manager or other entity may assign a particular weight to each question that is to be provided to an applicant 118 during a communications session with the bot recruiting agent 110 for the job opening or requisition. The bot recruiting agent 110 may be configured to utilize these weights and the responses provided by the applicant 118 to calculate an aggregated fitness grade or other score of the applicant 118. This calculation may be based on the degree of similarity between the applicant's response to each question and the desired response provided by the hiring manager or other entity for the question. For example, if a hiring manager or other entity has indicated that a desired candidate for a job opening or requisition is to have at least two years of work experience, the bot recruiting agent 110 may assign a higher score if the applicant 118 has indicated that it has at least two years of work experience, with the score increasing in proportion to the amount of work experience exceeding two years' worth up to a maximum limit for the particular question and according to the assigned weight.

Once the bot recruiting agent 110 has concluded a communications session with an applicant 118 (e.g., the bot recruiting agent 110 has obtained responses to each of the submitted questions, etc.), the bot recruiting agent 110 may submit the calculated fitness grade or score for the applicant 118, as well as any additional materials submitted by the applicant 118, to the applicant response data store 106. The calculated fitness grade or score for the applicant 118 and any provided additional materials may be stored in association with the particular job opening or requisition. This may allow the hiring manager or other entity to access and evaluate the applicant's fitness grade or score and any provided additional materials via the service dashboard 104.

In an embodiment, the bot creation engine 108 can associate and execute a single native conversational application for various job openings or requisitions. For instance, for a particular class or type of job opening or requisition submitted by a company 112, the bot creation engine 108 may implement a single native conversational application for the particular class or type of job opening or requisition. As an illustrative example, if a company 112 submits different job openings or requisitions related to a particular internal organization 114 and/or to a particular skill/profession (e.g., electrical engineer, software engineer, aerodynamicist, structural analyst, etc.), the bot creation engine 108 may associate a single native conversational application with these different job openings or requisitions such that if an applicant 118 selects any job opening or requisition from the website that corresponds to this set of job openings or requisitions, the bot creation engine 108 may execute the single native conversational application associated with the set.

As noted above, the recruiting automation service 102, via the service dashboard 104, may provide a platform for companies to generate and manage job openings or requisitions that may be made available to potential applicants 118. In an embodiment, a company 112, through the service dashboard 104, may designate different job openings or requisitions as being collectively associated with a particular internal organization 114, a particular skill/profession, or other attribute that defined a relationship that connects these different job openings or requisitions. For example, through the service dashboard 104, a company 112 may designate disparate job openings or requisitions as being associated with a specific internal organization 114, a specific skill code (e.g., a code that is uniquely associated with a particular skill or profession), or other designation that may be used to associate different job openings or requisitions with one another.

In an embodiment, the recruiting automation service 102 can use a machine learning algorithm or artificial intelligence to automatically recommend, to a company 112 (e.g., hiring managers, etc.), possible groupings for any current job openings or requisitions submitted by the company 112. The machine learning algorithm or artificial intelligence may be trained using unsupervised learning techniques. For instance, a dataset of input job openings or requisitions may be analyzed using a clustering algorithm to classify these job openings or requisitions according to a set of different classifications. These classifications may correspond to different internal organizations 114 within a company 112, different job types or skills, different seniority levels (e.g., senior engineering positions, managerial positions, etc.), and the like. Example clustering algorithms that may be trained using this dataset may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. The output of the machine learning algorithm or artificial intelligence may be provided to the company 112 (e.g., hiring managers, etc.) as a recommendation for grouping different job openings or requisitions together such that a single bot recruiting agent 110 may interact with applicants for any of these job openings or requisitions and provide, for the applicant 118, a grade or score for each of the job openings or requisitions within the group.

If the company 112 opts to group the identified set ofjob openings or requisitions together, the recruiting automation service 102 may associate these job openings or requisitions with a particular indicator (e.g., a unique identifier, a unique classification, etc.) that may denote a relationship between these different job openings or requisitions. This indicator may be used by the bot creation engine 108 to provision a single bot recruiting agent 110 for the different job openings or requisitions within the set. Further, this bot recruiting agent 110 may be configured to apply an applicant's responses provided for a particular job opening or requisition to the other job openings or requisitions within the set and to assign a grade or score according to the grading schemas implemented for these job openings or requisitions, as described in greater detail herein. Additionally, if the company 112 opts to group the identified set of job openings or requisitions together, the recruiting automation service 102 may utilize this feedback to further reinforce the machine learning algorithm or artificial intelligence configured to cluster different job openings or requisitions according to different classifications. This may increase the likelihood of similar job openings or requisitions being assigned the same or similar classification.

In some instances, if the company 112 indicates that the identified set of job openings or requisitions are not to be grouped together according to the classification specified by the machine learning algorithm or artificial intelligence (e.g., a hiring manager defines a different grouping for existing job openings or requisitions, a hiring manager determines to keep the existing job openings or requisitions separate, etc.), the recruiting automation service 102 may utilize this feedback to retrain the machine learning algorithm or artificial intelligence to decrease the likelihood of similar job openings or requisitions being clustered according to a particular classification. In some instances, the feedback may be used to define different classifications that may be used to more accurately cluster different job openings or classifications.

In an embodiment, if a company 112 associates different job openings or requisitions with a particular internal organization 114, skill code, or other designator that denotes a relationship between these different job openings or requisitions, the recruiting automation service 102 provides the parameters (e.g., selected questions and corresponding weights assigned by a hiring manager or other entity, etc.) of these different job openings or requisitions to a bot creation engine 108 for creation of a bot recruiting agent 110 associated with these job openings or requisitions. Similar to the process described above for associating a particular bot with a specific job opening or requisition, the parameters associated with each of the related but different job openings and requisitions may be provided in the form of executable instructions that may be executed via a web application or other application that implements a bot recruiting agent 110 for the particular set of job openings or requisitions. Thus, a bot recruiting agent 110 can be configured to autonomously chat with applicants 118 for any job opening or requisition from the set. Further, the bot recruiting agent 110 implemented for the set of job openings or requisitions can be configured to perform additional functions for any of the job openings or requisitions within the set. For instance, in an embodiment, the bot creation engine 108 can configure a bot recruiting agent 110 to automatically calculate each applicant's grade or other score based on evaluation of responses and materials provided by an applicant 118 during a communications session between the applicant 118 and the bot recruiting agent 110. Further, the bot creation engine 108 can configure the bot recruiting agent 110 to automatically identify and apply the applicable grading schema for the particular job opening or requisition from the set.

In an embodiment, the bot creation engine 108 can further configure a bot recruiting agent 110 implemented to communicate with an applicant 118 with regard to any job opening or requisition associated with the set to automatically calculate the applicant's grade or other score for any of the other job openings or requisitions of the set. For instance, responses provided by the applicant 118 to the bot recruiting agent 110 may be evaluated by the bot recruiting agent 110 according to the grading schema of not just the job opening or requisition that the applicant 118 is applying to but to the other grading schema defined for the other job openings or requisitions that are in the same set as the job opening or requisition that the applicant 118 is applying to. The different grading schemas may be provided by the bot creation engine 108 and configured based on the weights assigned to each of the corresponding questions by the hiring managers or other entities that submitted the job openings or requisitions that form the set. This may allow a company 112 to dynamically evaluate a particular applicant 118 for different, but related, job openings or requisitions to determine whether the applicant 118 is desirable for a particular job opening or requisition, whether the job opening or requisition is one that the applicant 118 directly applied to or is a different job opening or requisition that is associated with the job opening or requisition that the applicant 118 directly applied to. For example, if the applicant 118 is applying to a job opening or requisition for a senior software engineer for which the applicant 118 has not obtained a high grade or score, the company 112 may be able to evaluate the applicant's grade or score for other similar positions (e.g., a lower level software engineer, a senior software engineer position for which other skills are desirable, etc.) to determine whether the applicant 118 would be a better fit for any of these other similar positions.

In an embodiment, the recruiting automation service 102, via the service dashboard 104, provides a summary of the fitness scores of each applicant 118 that submitted an application for a particular job opening or requisition via a communications session with a bot recruiting agent 110. For instance, for each applicant 118, the recruiting automation service 102 may provide the applicant's fitness grade and score based on the responses and materials provided by the applicant 118. Additionally, the recruiting automation service 102 may provide a hiring manager or other entity, via the service dashboard 104, with an option to advance an applicant 118 to a next round of the recruiting process for the job opening or requisition. Selection of this option may cause the recruiting automation service 102 to automatically contact the applicant 118 to schedule an interview with the hiring manager or other entity that submitted the job opening or requisition. For instance, if a hiring manager or other entity selects an option to advance a particular applicant 118, the recruiting automation service 102 may transmit a communication to the applicant 118 with next steps for the job opening or requisition. This communication may be transmitted via a voice call, video call, a text-based communication (e.g., short message service (SMS) messaging, rich communication services (RCS) messaging, instant messaging, etc.), and the like.

In an embodiment, if the job opening or requisition is associated with a set of job openings or requisitions (e.g., by a particular classification or identifier), the recruiting automation service 102, via the service dashboard 104, provides a summary of the fitness scores of each applicant 118 that submitted an application for the job opening or requisition, as well as any other fitness scores of each applicant 118 for the other job openings or requisitions of the set. For instance, for a particular applicant 118, the recruiting automation service 102 may provide the applicant's fitness grade and score for the job opening or requisition that the applicant 118 has applied to, as well as the fitness grade and score for the other job openings or requisitions within the same set as the job opening or requisition that the applicant 118 applied to. This may allow the hiring manager or other entity with data that may be used to determine whether to advance the applicant 18 to a next round of the recruiting process for the job opening or requisition or to propose, to the applicant 118, an opportunity to apply for another job opening or requisition that the applicant 118 may be more suited for (as determined based on the various grades and scores for the different job openings or requisitions within the set).

In addition to providing a summary of the fitness scores of each applicant 118, the recruiting automation service 102, via the service dashboard 104, may make available any additional materials provided by each applicant 118. For instance, the recruiting automation service 102 may provide a link or network address corresponding to the storage location within the applicant response data store 106 of the additional materials provided by an applicant 118. Additionally, or alternatively, if an applicant 118 has provided a link or network address of a professional website associated with the applicant 118, the recruiting automation service 102 may make this link or network address available to the hiring manager or other entity via the service dashboard 104.

In an embodiment, the recruiting automation service 102 evaluates the responses to each of the questions asked to the applicants 118 to determine the average fit of the responses to these questions. For instance, the recruiting automation service 102 may compare the response to a particular question to the desired response provided by the hiring manager or other entity during creation of the new job opening or requisition. Based on the proximity of the response provided by an applicant 118 to the desired response for a particular question, the recruiting automation service 102 may determine a fitness score for the response. It should be noted that, in some instances, the fitness score for each response to a particular question may be calculated by the bot recruiting agent 110 associated with the job opening or requisition, as described above. The recruiting automation service 102 may calculate, based on the fitness score for each response to a particular question, the average response to the particular question and the corresponding fitness score for this average response. This information may be used to determine if applicants, on average, satisfy the requirements for the job opening or requisition.

In an embodiment, the recruiting automation service 102 utilizes a machine learning algorithm or artificial intelligence to generate recommendations for changes to questions provided to applicants 118 based on responses provided by applicants 118 to these questions. The recruiting automation service 102 may provide, as input to the machine learning algorithm or artificial intelligence, the questions submitted by the hiring manager or other entity, the desired responses to these questions, the actual responses to these questions as provided by applicants 118, and the level of importance of each question as defined by the hiring manager or other entity during creation of the job opening or requisition. The resulting output may specify the recommendations that may be used by the hiring manager or other entity to adjust the importance of each of the submitted questions and/or to change the questions submitted to applicants 118 for the job opening or requisition. The machine learning algorithm or artificial intelligence may be trained using supervised training techniques. For instance, a dataset of input questions, desired responses, sample responses, sample importance levels for these questions, and corresponding recommendations can be selected for training of the machine learning algorithm or artificial intelligence. In some examples, the desired recommendations can be provided by administrators of the recruiting automation service 102, hiring managers, or other sources associated with the recruiting automation service 102. In some implementations, known recommendations used to train the machine learning algorithm or artificial intelligence may correspond to desired changes to the importance levels of submitted questions or changes to the submitted questions as indicated by the entity that submitted the sample questions and importance levels. The machine learning algorithm or artificial intelligence may be evaluated to determine, based on the input sample questions, importance levels, desired responses, and actual responses supplied to the machine learning algorithm or artificial intelligence, whether the machine learning algorithm or artificial intelligence is providing useful recommendations that can be provided to the hiring manager or other entity submitting the job opening or requisition. Based on this evaluation, the machine learning algorithm or artificial intelligence may be modified (e.g., one or more parameters or variables may be updated) to increase the likelihood of the machine learning algorithm or artificial intelligence generating the desired recommendations.

In an embodiment, the recruiting automation service 102 provides any determined recommendations for changes to the submitted questions to the hiring manager or other entity via the service dashboard 104. The recruiting automation service 102 may provide, to the hiring manager or other entity, one or more tools to change the parameters of each of the questions submitted to applicants 118 for the corresponding job opening or requisition. For instance, via the service dashboard 104, a hiring manager or other entity may adjust the level of importance for each of the submitted questions. Further, via the service dashboard 104, the hiring manager or other entity may change the desired response for each of the submitted questions. Thus, via the service dashboard 104, a hiring manager or other entity may be able to dynamically change the parameters of an active job opening or requisition.

In an embodiment, if the hiring manager or other entity adjusts the level of importance or otherwise adjusts a particular question (e.g., changes a desired response, etc.), the recruiting automation service 102 dynamically changes the fitness grade or score for each applicant 118. For instance, the recruiting automation service 102 may calculate a new fitness grade or score for an applicant 118 based on the proximity of the applicant's response to the new desired response for a modified question. Alternatively, if the hiring manager or other entity adjusts the level of importance for a particular question, the recruiting automation service 102 may adjust the weight for the particular question accordingly. Based on this new weight, the recruiting automation service 102 may dynamically calculate a new fitness grade or score for each applicant 118 and present these new fitness grades or scores to the hiring manager or other entity via the service dashboard 104. Thus, a hiring manager or other entity may dynamically adjust any parameter of a job opening or requisition and cause the recruiting automation service 102 to automatically adjust the fitness grades or scores for the applicants 118 without having to solicit new responses from these applicants 118.

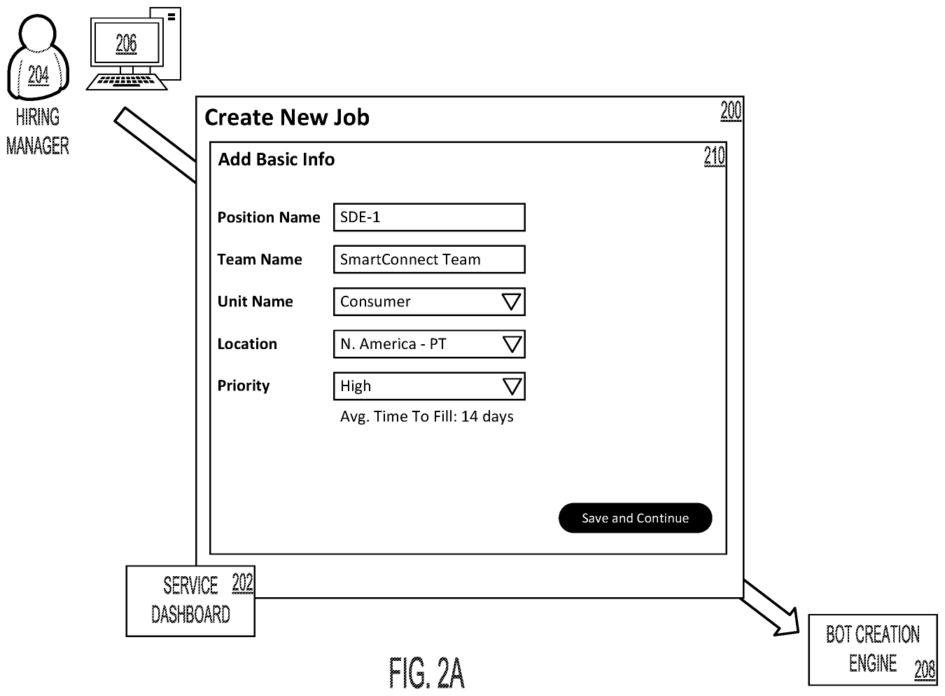

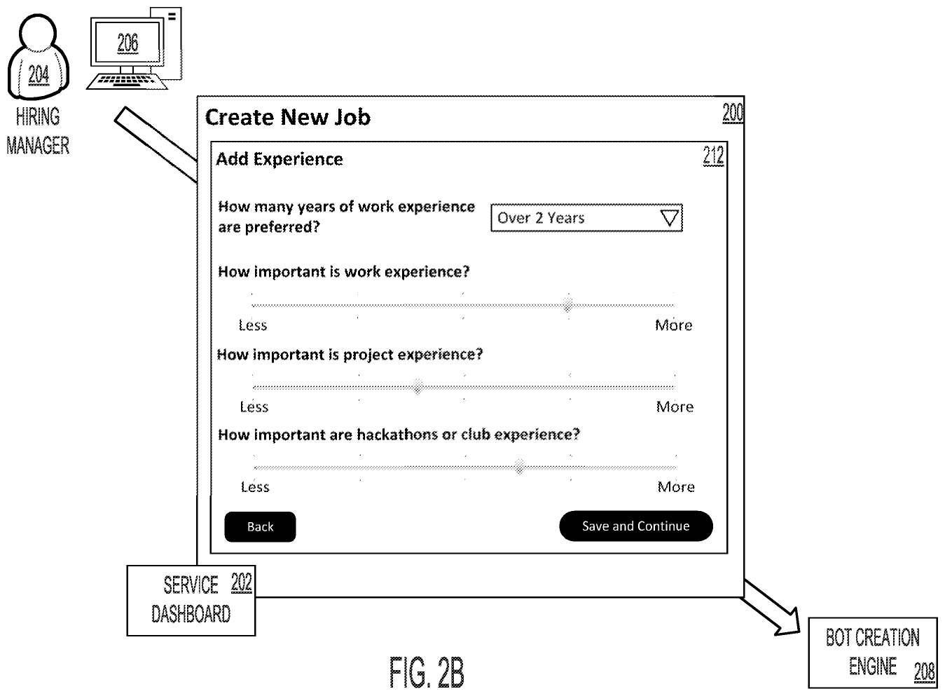

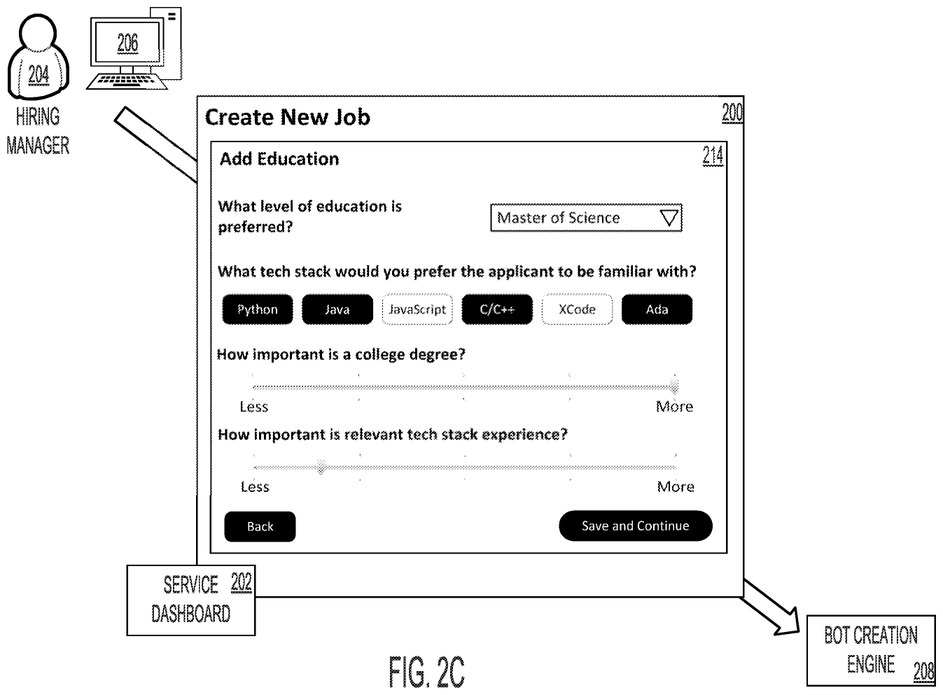

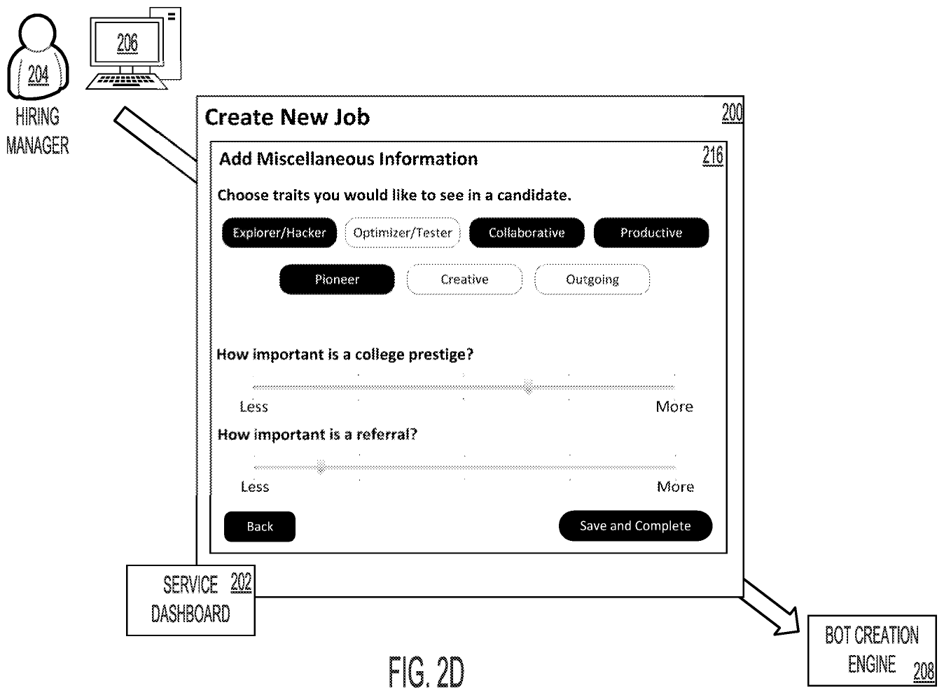

FIGS. 2A-2D show an illustrative example of an interface 200 provided via a service dashboard 202 that can be used to generate a new job opening or requisition and define parameters for configuration of a bot recruiting agent for the new job opening or requisition in accordance with at least one embodiment. As illustrated in FIG. 2A, a hiring manager 204, via a computer system 206, may access the service dashboard 202 of the recruiting automation service to create a new job opening or requisition. In an embodiment, the service dashboard 202 provides, to users that access the recruiting automation service, an interface 200 through which a user (e.g., hiring manager 204, etc.) may generate and submit a new job opening or requisition. Further, the inputs provided by the hiring manager 204 via the interface 200 may be used by a bot creation engine 208 to configure a bot recruiting agent that may interact with potential applicants that access the job opening or requisition.

As illustrated in FIG. 2A, the service dashboard 202 may provide a hiring manager 204 with a requisition definition panel 210 via the interface 200, through which a hiring manager 204 may provide basic information regarding the job opening or requisition that is to be presented to potential applicants by the recruiting automation service. For instance, via the requisition definition panel 210, a hiring manager 204 may provide a name for the position associated with the job opening or requisition and a name of the team associated with the job opening or requisition. Further, the service dashboard 202 may provide one or more options for selection of an organizational unit that is to be associated with the job opening or requisition. In an embodiment, during an onboarding process for a particular company or organization, a hiring manager or other entity associated with the particular company or organization may be prompted to define the different organizational units for which job openings or requisitions may be created. These different organizational units may be presented to the hiring manager 204 within the requisition definition panel 210 for selection.

In addition to defining different organizational units associated with a particular company or organization, a hiring manager or other entity may further define the one or more locations for each of these different organizational units. These one or more locations may correspond to physical company or organization sites where the different organizations units may be located. In an embodiment, the recruiting automation service associates each organizational unit with any locations defined by a hiring manager or other entity for the organizational unit. Thus, based on the hiring manager 204 selection of a unit name via the requisition definition panel 210, the service dashboard 202 may update the requisition definition panel 210 to indicate the different locations associated with the selected organizational unit that may be selected for the new job opening or requisition.

In an embodiment, the service dashboard 202 provides, via the requisition definition panel 210, an option to define the priority for the new job opening or requisition. The priority for the new job opening or requisition may be used to determine the average time that may be required to fill the new job opening or requisition. For example, in an embodiment, the recruiting automation service tracks each job opening or requisition submitted by the hiring manager 204 or company/organization associated with the hiring manager 204 to determine the amount of time required to fill the job opening or requisition. For instance, via the requisition automation service, a hiring manager 204 may indicate when applicants are advanced to the next stage of the hiring process (e.g., tech processing, interviews, etc.) and when the job opening or requisition has been filled. The time taken to reach this point may be recorded by the recruiting automation service. Thus, based on the priority selected by a hiring manager 204 for a new job opening or requisition, the recruiting automation service may calculate, based on the time required to fill previously submitted job openings or requisitions having the same priority and associated with the company/organization, the average time for filling the new job opening or requisition.

As illustrated in FIG. 2B, the service dashboard 202 may further provide, via an experience definition panel 212 of the interface 200, various options for defining the parameters or metrics corresponding to questions related to an applicant's level of experience that may be submitted to potential applicants for the new job opening or requisition. The questions related to an applicant's level of experience may be provided to the hiring manager 204 by the recruiting automation service. For instance, the questions presented via the experience definition panel 212 may be provided by the recruiting automation service by default (as defined by an administrator or other entity associated with the recruiting automation service). Alternatively, the questions presented via the experience definition panel 212 may be defined by the hiring manager 204 or other entity associated with the company/organization during an onboarding process of the recruiting automation engine. For instance, during this onboarding process, a company/organization may specify what questions are to be submitted to applicants for particular types of job openings or requisitions. These types may correspond to the organization units for which a job opening or requisition is being created. In some embodiments, a hiring manager 204, via the experience definition panel 212 may define new experience-related questions that may be presented to potential applicants for the new job opening or requisition.

In an embodiment, the recruiting automation service provides, via the experience definition panel 212, one or more options for defining the level of importance for each experience-related question that is to be asked of an applicant. For instance, as illustrated in FIG. 2B, the experience definition panel 212 may include a slider for each experience-related question. Using a slider, the hiring manager 204 may determine the level of importance for a particular experience-related question. As an illustrative example, a hiring manager 204 may indicate that an applicant's work experience is more important, whereas an applicant's project experience is less important. In some instances, the hiring manager 204, via the experience definition panel 212 may also define desired responses to submitted questions. For example, via the experience definition panel 212, a hiring manager 204 may indicate that an applicant is preferred to have over two years of work experience. As described in greater detail herein, a bot recruiting agent may evaluate an applicant's response and identify a deviation from the desired response, if any. Based on this deviation, the bot recruiting agent may determine a score for the particular question.

In an embodiment, the recruiting automation service utilizes the level of importance for each experience-related question to calculate a scoring weight for each question. For instance, if the hiring manager 204 indicates that a particular experience-related question is of more importance, the recruiting automation service may assign a greater weight to the particular experience-related question. Alternatively, if the hiring manager 204 indicates that a particular experience-related question is of lesser importance, the recruiting automation service may assign a lesser weight to the particular experience-related question. In an embodiment, the weights may be calibrated such that a resulting aggregated score for each applicant falls within a pre-defined range (e.g., 0-100, etc.). The value of the corresponding weight for a particular question may be determined based on the position of the slider or other indication provided by the hiring manager 204 related to the level of importance of the particular question.

As illustrated in FIG. 2C, the service dashboard 202 may further provide, via an education definition panel 214 of the interface 200, various options for defining the parameters or metrics corresponding to questions related to an applicant's level of education that may be submitted to potential applicants for the new job opening or requisition. The questions related to an applicant's level of education may be provided to the hiring manager 204 by the recruiting automation service. For instance, the questions presented via the education definition panel 214 may be provided by the recruiting automation service by default (as defined by an administrator or other entity associated with the recruiting automation service). Alternatively, the questions presented via the education definition panel 214 may be defined by the hiring manager 204 or other entity associated with the company/organization during an onboarding process of the recruiting automation engine. For instance, during this onboarding process, a company/organization may specify what questions are to be submitted to applicants for particular types of job openings or requisitions. These types may correspond to the organization units for which a job opening or requisition is being created. In some embodiments, a hiring manager 204, via the education definition panel 214 may define new education-related questions that may be presented to potential applicants for the new job opening or requisition.

Similar to the experience definition panel 212 described above and illustrated in FIG. 2B, the recruiting automation service may provide, via the education definition panel 214, one or more options for defining the level of importance for each education-related question that is to be asked of an applicant. For instance, as illustrated in FIG. 2C, the recruiting automation service may provide a slider or other interactive element through which the hiring manager 204 may define the level of importance for the corresponding education-related question. As an illustrative example, the hiring manager 204 may indicate, using a slider or other interactive element, that questions related to an applicant's college degree are of paramount importance while questions related to an applicant's relevant tech stack experience are of lesser importance.

In addition to allowing a hiring manager 204 to determine the level of importance for different education-related questions, the recruiting automation service may provide the hiring manager 204 with one or more options for selecting skills preferred for the job opening or requisition. The one or more options presented via the education definition panel for a particular education-related question may be defined during an onboarding process for a particular company or organization. During this onboarding process, a hiring manager or other entity associated with the particular company or organization may provide relevant options for particular questions that are to be presented for particular types of job openings or requisitions. For example, if a job opening or requisition corresponds to an organizational unit related to software development, a hiring manager or other entity may define options related to software development for questions related to an applicant's education or technical experience. As an illustrative example, for a question related to an applicant's familiarity with different tech stacks, a hiring manager or other entity may define different tech stack options that may be presented to an applicant. Further, these different tech stack options may be presented to the hiring manager 204 via the education definition panel 214 to allow the hiring manager 204 to select one or more preferred tech stacks for the job opening or requisition.

In some instances, the hiring manager 204, via the education definition panel 214 may also define desired responses to submitted questions. For example, via the education definition panel 214, a hiring manager 204 may indicate that an applicant is preferred to have at least a Master of Science degree for the job opening or requisition. As described in greater detail herein, a bot recruiting agent may evaluate an applicant's response and identify a deviation from the desired response, if any. Based on this deviation, the bot recruiting agent may determine a score for the particular question.

In an embodiment, the recruiting automation service utilizes the level of importance for each education-related question to calculate a scoring weight for each question. For instance, if the hiring manager 204 indicates that a particular education-related question is of more importance, the recruiting automation service may assign a greater weight to the particular education-related question. Alternatively, if the hiring manager 204 indicates that a particular education-related question is of lesser importance, the recruiting automation service may assign a lesser weight to the particular education-related question. In an embodiment, the weights may be calibrated such that a resulting aggregated score for each applicant falls within a pre-defined range. The value of the corresponding weight for a particular question may be determined based on the position of the slider or other indication provided by the hiring manager 204 related to the level of importance of the particular question. Further, the weights may be calibrated across the different types of questions (e.g., experience, education, miscellaneous, etc.) as defined via the interface 200.

As illustrated in FIG. 2D, the service dashboard 202 may further provide, via a miscellaneous information definition panel 216 of the interface 200, various options for defining the parameters or metrics corresponding to questions for soliciting miscellaneous information from potential applicants that may be useful in determining an applicant's fit for the new job opening or requisition. Through the miscellaneous information definition panel 216, a hiring manager 204 may define the preferred responses or attributes of an applicant that may be desirable for the job opening or requisition. For example, as illustrated in FIG. 2D, a hiring manager 204 may be presented with various options for traits that are desired in an applicant for the job opening or requisition. These traits may be pre-defined by a hiring manager or other entity associated with a company/organization during an onboarding process. For instance, during an onboarding process, a hiring manager or other entity may define different traits for different organizational units that may be selected for job openings or requisitions for these different organizational units.

In addition to defining preferred responses or attributes of an applicant, a hiring manager 204, via the miscellaneous information definition panel 216 may further define a level of importance for different elements of applicant responses. For example, in addition to defining the level of importance regarding the level of an applicant's degree, a hiring manager 204 may define the level of importance with regard to the prestige of the university or college from which the applicant obtained the degree. In an embodiment, the recruiting automation service may access a source of data (e.g., websites, databases, repositories, etc.) that may be used to determine the prestige of an applicant's stated university or college. For example, the recruiting automation service may access a source of data that indicates the rankings of universities and colleges for particular degrees and fields in order to determine the level of prestige of an applicant's stated university or college. Similar to the other questions described above, the recruiting automation service may determine a scoring weight for the level of prestige or other traits identified from an applicant's responses. For example, using a slider or other interactive element, a hiring manager 204 may define the level of importance regarding university or college prestige, referrals, selected traits, and the like. Based on these definitions, the recruiting automation service may determine the scoring weight for each of these questions or elements associated with applicant responses.

In an embodiment, once the hiring manager 204 has defined the level of importance for each question that is to be provided to potential applicants for the job opening or requisition, the requisition automation service may transmit instructions to the bot creation engine 208 to configure a bot recruiting agent for the job opening or requisition. For instance, the recruiting automation service may provide the bot creation engine 208 with instructions specifying the questions that are to be asked and the corresponding weights for each of these questions. In some instances, the recruiting automation service may provide the bot creation engine 208 with one or more formulae that may be used by a bot recruiting agent to automatically calculate an applicant's score or grade for the job opening or requisition based on the responses submitted by the applicant. As noted above, the bot creation engine 208 may host a native conversational application that is configured to use bot recruiting agents to communicate with applicants and dynamically update content as applicants provide responses to questions provided by the bot recruiting agents via communications sessions between the bot recruiting agents and the applicants.

In an embodiment, the inputs provided by the hiring manager 204 via the interface 200 are used as input to a machine learning algorithm or artificial intelligence to determine whether the new job opening or requisition being created may be associated with other existing job openings or requisitions previously submitted by the hiring manager 204 or other entity associated with company or other organization. For instance, the various inputs provided by the hiring manager 204, as illustrated in FIGS. 2A-2D, may be used as input to the machine learning algorithm or artificial intelligence in order to classify the new job opening or requisition according to any of the available classifications for existing job openings or requisitions. For example, if the new job opening or requisition corresponds to the company's consumer unit, located on the West Coast of North America, and requires familiarity with particular tech stacks and desirable traits, the machine learning algorithm or artificial intelligence may use these vectors of similarity to identify a particular cluster that best corresponds to these vectors of similarity.

If the machine learning algorithm or artificial intelligence identifies a particular cluster or classification for the new job opening or requisition, the recruiting automation service, through the service dashboard 202, may present the identified cluster or classification for the new job opening or requisition to the hiring manager 204. Additionally, the recruiting automation service may present, through the service dashboard 202, any other existing job openings or requisitions that may be associated with the identified cluster or classification. This may allow the hiring manager 204 to determine whether to accept the proposed classification for the new job opening or requisition such that the new job opening or requisition may be clustered with the other existing job openings or requisitions. Further, this may allow the bot creation engine 208 to assign a single bot recruiting agent associated with the identified cluster or classification to communicate with an applicant for the new job opening or requisition and to grade or score the applicant according to the grading schema for the new job opening or requisition and to the other grading schemas associated with the other job openings or requisitions associated with the identified cluster or classification. This may allow the hiring manager 204 to obtain different grades or scores for an applicant across different job openings or requisitions and determine whether the applicant is ideal for the new job or requisition that the applicant has applied to or for a different job opening or requisitions associated with the cluster or classification.

In an embodiment, feedback from the hiring manager 204 may be used to retrain the machine learning algorithm or artificial intelligence used to identify a classification or cluster for the new job opening or requisition. For example, if the hiring manager 204 accepts the provided recommendation to associate the new job opening or requisition with a particular classification or cluster (e.g., a particular set of existing job openings or requisitions), the recruiting automation service may use this acceptance as feedback that may be used to reinforce the machine learning algorithm or artificial intelligence such that similar job openings or requisitions created by the hiring manager 204 or other entity associated with the same company, organizational unit, etc., are more likely to be assigned to the same or similar classification or cluster. Alternatively, if the hiring manager 204 rejects the provided recommendation to associate the new job opening or requisition with a particular classification or cluster, the recruiting automation service may use this rejection as feedback that may be used to retrain the machine learning algorithm or artificial intelligence such that similar job openings or requisitions created by the hiring manager 204 or other entity associated with the same company, organizational unit, etc., are less likely to be assigned to the previously recommended classification or cluster.

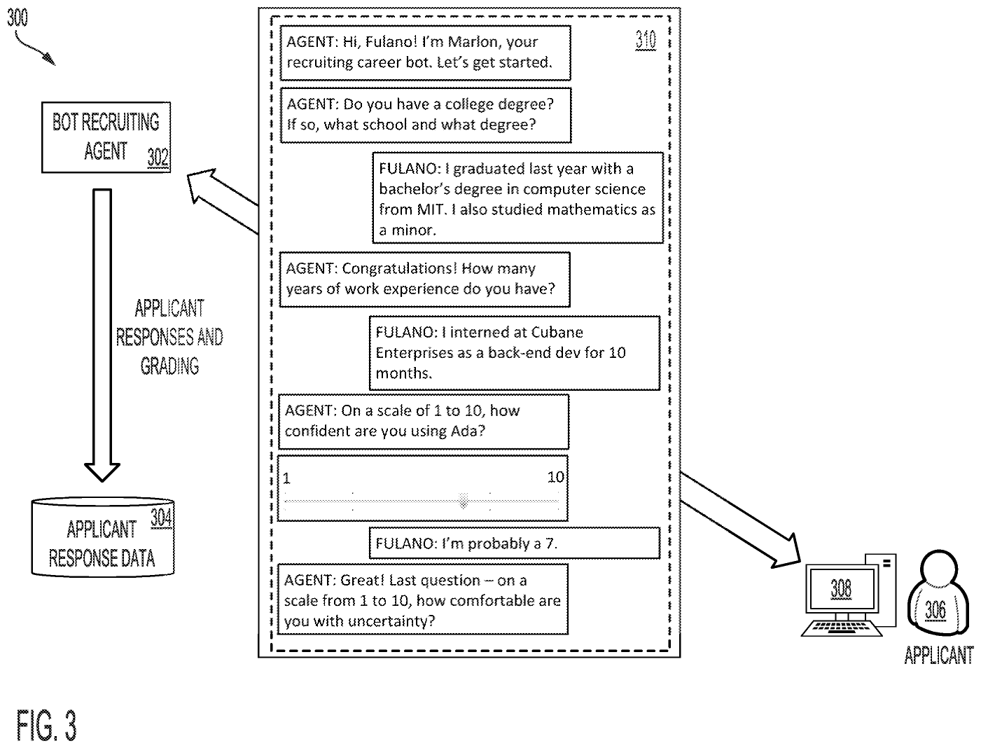

FIG. 3 shows an illustrative example of an environment 300 in which a bot recruiting agent 302 engages in a communications session 310 with an applicant 306 to solicit and obtain responses from the applicant for a job opening or requisition in accordance with at least one embodiment. In the environment 300, an applicant 306, via a computing device 308, may engage in a communications session 310 with a bot recruiting agent 302 in order to apply for a particular job opening or requisition made available via a website or other network location by the recruiting automation service. For instance, via the web site or other network location, the applicant 306 may review any available job openings or requisitions that the applicant 306 may be interested in. Each job opening or requisition may be presented using its corresponding name (as provided by a hiring manager) and any keywords or summaries that may be used to identify any details regarding the job opening or requisition.

In an embodiment, if an applicant 306 selects a particular job opening or requisition, the recruiting automation service may execute the corresponding bot recruiting agent 302 for the particular job opening or requisition or for the set of j ob openings or requisitions that the particular job opening or requisition belongs to and establish a communications session 310 between the bot recruiting agent 302 and the applicant 306 via the applicant's computing device 308. In some instances, prior to establishing the communications session 310, the recruiting automation service may prompt the applicant 306 to provide basic information about the applicant 306, such as the applicant's name, contact information, and the like. In some instances, if the recruiting automation service requires creation or maintenance of a user account in order to access job openings or requisitions, the recruiting automation service may automatically obtain the applicant's basic information and provide this to the bot recruiting agent 302.

In an embodiment, once the communications session 310 has been established, the bot recruiting agent 302 may use NLP or other artificial intelligence to query the applicant 306 for responses that can be used to determine the applicant's fitness (e.g., grade, score, etc.) for the particular job opening or requisition. For instance, based on the executable instructions provided by the recruiting automation service, the bot recruiting agent 302 may use NLP or other artificial intelligence to ask the applicant 306 the various questions selected by a hiring manager or otherwise approved by the hiring manager for the job opening or requisition. For instance, as illustrated in FIG. 3, the bot recruiting agent 302 may converse with the applicant 306 by first introducing itself to the applicant 306 and asking the applicant 306 to indicate whether the applicant 306 has a college degree and, if so, the corresponding school from which the degree was obtained and the type of degree obtained.

Once the bot recruiting agent 302 has asked the applicant 306 a question, the bot recruiting agent 302 may wait a pre-defined amount of time for the applicant 306 to provide a response. If the applicant 306 does not provide a response within this pre-defined amount of time, the bot recruiting agent 302 may repeat the question to the applicant 306 over the communication session 310. In some instances, if the bot recruiting agent 302 determines that the applicant 306 has not provided a response to the question within the pre-defined period of time, the bot recruiting agent 302 may terminate the communication session and calculate a score or grade for the applicant 306 based on any responses previously submitted. In other instances, the bot recruiting agent 302 may store a null response for the question and ask a different question to the applicant 306 over the communications session 310. If the applicant 306 subsequently fails to respond to the different question or is otherwise unresponsive over a threshold period of time, the bot recruiting agent 302 may terminate the communications session 310 and calculate a score or grade for the applicant 306 based on any previously submitted responses.

In an embodiment, if the applicant 306 submits a response to a question via the communications session 310, the bot recruiting agent 302 evaluates the response and calculates a score or grade for the particular response according to the weight assigned to the corresponding question by the recruiting automation service. For instance, bot recruiting agent 302 may use a machine learning algorithm or artificial intelligence to process the applicant's response in order to identify and extract information that may be used to determine evaluate the response and determine the score or grade for the response. The machine learning algorithm may be used to perform a semantic analysis of the responses (e.g., by identifying keywords, sentence structures, repeated words, punctuation characters and/or non-article words) to identify the information in the response that may be used to determine the score or grade corresponding to a level of fitness of the response to a desired response for the corresponding question. The machine learning algorithm utilized by the bot recruiting agent 302 may be dynamically trained using supervised learning techniques. For instance, a dataset of input responses and known desired responses for different questions can be selected for training of the machine learning algorithm. The machine learning algorithm may be evaluated to determine, based on the input sample responses supplied to the machine learning algorithm, whether the machine learning algorithm is identifying the correct information from the responses and calculating an accurate score or grade for the response. Based on this evaluation, the machine learning algorithm may be modified to increase the likelihood of the machine learning algorithm generating the desired results.

The bot recruiting agent 302, in response to obtaining a response from the applicant 306 to a particular question, may select another question and present this to the applicant 306 via the communications session 310. In some instances, the bot recruiting agent 302 may use the previous response, as well as NLP or other artificial intelligence, to tailor the subsequent question in a way that is also responsive to the previously provided response. For example, as illustrated in FIG. 3, the bot recruiting agent 302 may congratulate the applicant 306 on obtaining a bachelor's degree in computer science from a prestigious university based on the applicant's prior response and proceed to ask the applicant 306 about the applicant's work experience. This may provide a more natural conversation between the applicant 306 and the bot recruiting agent 302.

In an embodiment, the bot recruiting agent 302 can also provide, via the communications session 310, one or more interactive elements that may be used by an applicant 306 to indicate a level of comfort or confidence in a particular area. For example, as illustrated in FIG. 3, the bot recruiting agent 302 may ask the applicant 306 to define, on a given scale, the applicant's level of confidence using a particular programming language. Additionally, the bot recruiting agent 302 may provide a slider or other interactive element through which the applicant 306 may define its level of confidence using the particular programming language, thereby forming a response to the question from the bot recruiting agent 302. The bot recruiting agent 302 may use the selection to determine the applicant's response and calculate a score or grade for the response.

The bot recruiting agent 302 may continue to ask the applicant 306 questions related to the job opening or requisition until the pool of questions corresponding to the job opening or requisition has been exhausted. The bot recruiting agent 302 may calculate the grade or score for each response according to the weights assigned to the corresponding questions and/or formulae defined by the recruiting automation service. Further, the bot recruiting agent 302 may aggregate the grades or scores for the submitted responses to generate an aggregated fitness score or grade for the applicant 306. The fitness score or grade may be represented as a letter grade (e.g., A-F, etc.) representing the applicant's fitness for the job opening or requisition. Additionally, or alternatively, the fitness score or grade may be represented using a numerical value (e.g., 0-100%, etc.). This numerical value may correspond to the aforementioned letter grade, whereby each possible letter grade may correspond to a range of numerical values.

In an embodiment, if the bot recruiting agent 302 is associated with a set of job openings or requisitions, the bot recruiting agent 302 can calculate the grade or score for each response according to the weights assigned to the corresponding questions and/or formulae defined by the recruiting automation service for each of the job openings or requisitions of the set. For each of these job openings or requisitions, the bot recruiting agent 302 may aggregate the grades or scores for the submitted responses according to the corresponding grading schema for each job opening or requisition to generate an aggregated fitness score or grade for the applicant 306 and that corresponds to the particular job opening or requisition. Thus, while the applicant 306 may interact with the bot recruiting agent 302 for a particular job opening or requisition that the applicant 306 is applying to, the bot recruiting agent 302 may calculate the applicant's grade or score for other existing job openings or requisitions that may be associated with the particular job opening or requisition that the applicant 306 is applying to. Further, because each job opening or requisition may have its own grading schema, the bot recruiting agent 302 may apply these different grading schemas to the applicant's responses such that the applicant 306 may be assigned different grades or scores for the different job openings or requisitions of the set.

In an embodiment, the bot recruiting agent 302 stores the provided responses and applicant fitness score and/or grade within an applicant response data store 304. As described in greater detail herein, a hiring manager may access the service dashboard of the recruiting automation service to evaluate the fitness scores and/or grades of applicants to a job opening or requisition. Thus, when a hiring manager access the service dashboard to evaluate the fitness of applicants for a particular job opening or requisition, the recruiting automation service may access the applicant response data store 304 to obtain the fitness scores and/or grades for the applicants and present these to the hiring manager via the service dashboard. In some instances, the recruiting automation service may evaluate the individual grades or scores for each response to determine an average level of fitness of responses to each question. Based on this average level of fitness of responses to each question, the recruiting automation service may provide recommendations to the hiring manager or other entity that submitted the job opening or requisition for updating the parameters or metrics (e.g., level of importance, desired response, etc.) corresponding to the question.

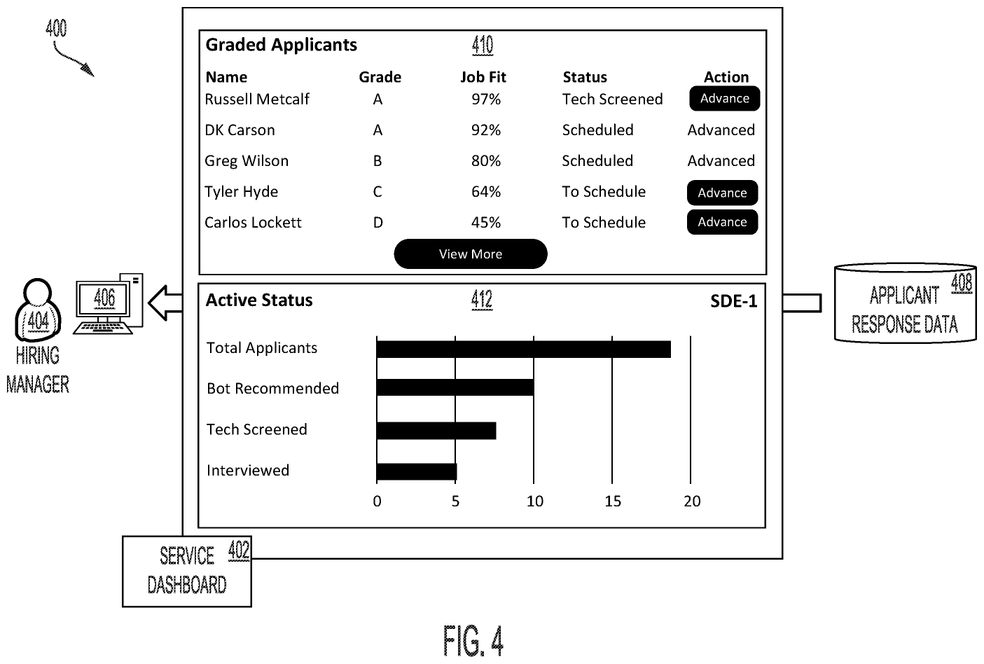

FIG. 4 shows an illustrative example of an environment 400 in which a hiring manager 404 is provided with applicant grades and the status of a job opening or requisition via a user interface in accordance with at least one embodiment. In the environment 400, a hiring manager 404, via a computing device 406, may access a service dashboard 402 of the recruiting automation service to review the fitness of applicants for a particular job opening or requisition. For instance, via the service dashboard 402, a hiring manager 404 may select a particular job opening or requisition previously created by the hiring manager 404 or other entity for a company or organization. If the hiring manager 404 selects a particular job opening or requisition, the recruiting automation service may retrieve, from the applicant response data store 408, applicant data associated with the particular job opening or requisition. This applicant data may include applicant names, applicant fitness grades, applicant fitness scores, applicant statuses (e.g., tech screened, interview scheduled, interview to be scheduled, etc.), and the like. Further, the recruiting automation service may provide metrics regarding the overall performance of applicants as a whole.

As illustrated in FIG. 4, the service dashboard 402 may provide, via an interface, a graded applicants panel 410, through which a hiring manager 404 may be provided with each applicant's fitness grade and corresponding score. The applicants presented via the graded applicants panel 410 may be ordered such that applicants having a better (e.g., higher) fitness grade and score are presented first within the graded applicants panel 410. In addition to providing a fitness grade and fitness score for each applicant, the service dashboard 402 may also provide a status for each applicant and an option to advance the applicant for additional interaction with the hiring manager 404 or other entity associated with the company or organization (e.g., interviews, etc.). Further, if an applicant has been advanced, the service dashboard 402 may indicate the status of the applicant (e.g., interview scheduled, etc.).

In an embodiment, the service dashboard 402 provides the hiring manager 404 with an option to advance an applicant along the application process for the job opening or requisition. If a hiring manager 404 selects this option, the recruiting automation service may automatically transmit a notification to the corresponding applicant to indicate that the applicant is being advanced in the application process. For example, the recruiting automation service may transmit a notification to the applicant to contact the hiring manager 404 in order to schedule a follow-up interview for the job opening or requisition. The notification may include contact information of the hiring manager 404 or of another entity that may schedule interviews on behalf of the hiring manager 404 (e.g., e-mail address, telephone number, etc.). Further, the notification may be transmitted to the applicant via one or more communications channels (e.g., e-mail, Short Message Service (SMS) message, Multimedia Messaging Service (MMS) message, text message, etc.).

In some instances, the recruiting automation service may schedule an interview for the applicant on behalf of the hiring manager 404. For instance, if the hiring manager 404 selects an option to advance a particular applicant, the recruiting automation service may prompt the hiring manager 404 to provide available times for an interview with the applicant. The recruiting automation service may present these times to the applicant, which may choose any of the available times for the interview. The recruiting automation service may provide a confirmation for the selected time and reserve the selected time for the interview. Further, the recruiting automation service may update the graded applicants panel 410 to indicate that the applicant has been advanced and that an interview has been scheduled.

In addition to the graded applicants panel 410, the service dashboard 402 may also present, via an interface, an active status panel 412. Through the active status panel 412, the recruiting automation service may provide a breakdown of the status the pool of applicants for the job opening or requisition. For example, as illustrated in FIG. 4, a hiring manager 404 may be provided, via the active status panel 412, with details regarding the total number of applicants for the job opening or requisition, the number of applicants recommended by the bot recruiting agent associated with the job opening or requisition (e.g., applicants having a fitness score or grade above a threshold value, etc.), the number of applicants that have been tech screened, and the number of applicants that have been interviewed for the job opening or requisition. This may provide the hiring manager 404 with insights regarding the quality of applicants that have applied for a particular job opening or requisition.

In an embodiment, the recruiting automation service can provide insights with regard to the active status of the job opening or requisition based on the number of applicants recommended by a bot recruiting agent and the number of applicants that have actually been tech screened and/or interviewed for the job opening or requisition. For example, if the number of applicants that have been tech screened and/or interviewed is significantly lower than the number of applicants recommended by the bot recruiting agent, the recruiting automation service may determine whether the discrepancy is a result of the hiring manager 404 disagreeing with the assessment of the bot recruiting agent (e.g., responses receiving a high grade or score do not comport with hiring manager expectations, etc.) or the result of an inefficiency within the company or organization (e.g., understaffing of recruiters, unavailability of the hiring manager 404, etc.).

In an embodiment, the recruiting automation service can use a machine learning algorithm or artificial intelligence to provide said insights to the hiring manager 404. The machine learning algorithm utilized by the recruiting automation service may be dynamically trained using supervised learning techniques. For instance, a dataset of input applicant data (e.g., number of applicants recommended by a bot recruiting agent, number of applicants that have been tech screened, number of applicants that have been interviewed, responses submitted by applicants, calculated fitness grades/scores, etc.), known causes for discrepancies, and solutions to these discrepancies can be selected for training of the machine learning algorithm or artificial intelligence. In some implementations, known causes for discrepancies used to train the machine learning algorithm may include characteristics of hiring managers and/or companies/organizations associated with the sample job openings or requisitions (e.g., number of recruiters available, availability of hiring managers, etc.). Further, the known causes for discrepancies used to train the machine learning algorithm may include any determinations that the grading/scoring performed by bot recruiting agents is inaccurate or not indicative of an applicant's fitness for a particular job opening or requisition.

The machine learning algorithm may be evaluated to determine, based on the input sample applicant data, corresponding job openings or requisitions, known causes for discrepancies, and sample solutions supplied to the machine learning algorithm, whether the machine learning algorithm is identifying the expected solutions or recommendations for addressing any identified discrepancies or issues. Based on this evaluation, the machine learning algorithm may be modified to increase the likelihood of the machine learning algorithm generating the desired results. The machine learning algorithm may further be dynamically trained by soliciting feedback from hiring managers with regard to provided recommendations.

In an embodiment, the recruiting automation service can provide the determined recommendations or insights regarding any discrepancies between the number of applicants recommended by a bot recruiting agent and the number of applicants actually tech screened and/or interviewed within the active status panel 412. This may allow the hiring manager 404 to review these recommendations or insights and take any necessary action to address any identified discrepancies. Further, via the active status panel 412, the hiring manager 404 may provide feedback with regard to the provided recommendations or insights, which may be used to further dynamically train the machine learning algorithm or artificial intelligence, as described above.

In an embodiment, the recruiting automation service can further provide an indication as to whether an applicant has obtained a higher fitness grade and corresponding score for a different job opening or requisition that may be associated with the particular job opening or requisition being presented to the hiring manager 404. As noted above, the recruiting automation service may classify each new job opening or requisition such that job openings or requisitions having a particular classification may be clustered together. This may allow for use of a single bot recruiting agent to determine an applicant's fitness grade and corresponding score for each of the job openings or requisitions assigned to a particular classification when the applicant applies to any of the job openings or requisitions assigned to the particular classification. Accordingly, through the service dashboard 402, the hiring manager 404 may be provided with an indication as to whether any of the applicants presented in the graded applicants panel 410 have obtained a higher fitness grade and corresponding score for a different job opening or requisition that is associated with the particular job opening or requisition being presented. The service dashboard 402 may further provide the hiring manager 404 to advance an applicant for the different job opening or requisition directly through the graded applicants panel 410 rather than requiring the hiring manager 404 to submit a request to access the different job opening or requisition through the service dashboard 402.

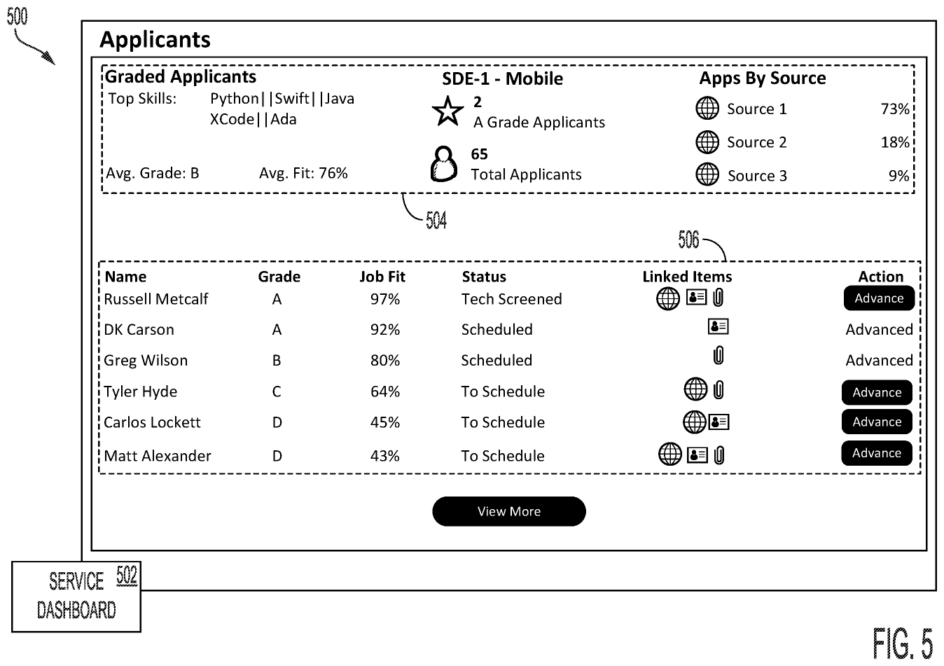

FIG. 5 shows an illustrative example of an interface 500 provided via a service dashboard 502 for evaluation of applicant grades, provided materials, and metrics associated with a job opening or requisition in accordance with at least one embodiment. The interface 500 may be updated to provide additional details regarding the pool of applicants for a particular job opening or requisition. For instance, the interface 500 may include a job opening detailed summary 504 that provides different insights with regard to the pool of applicants for the particular job opening or requisition. For example, as illustrated in FIG. 5, the job opening detailed summary 504 may include a listing of the top skills identified from applicant responses to questions submitted to applicants by a bot recruiting agent. Further, the job opening detailed summary 504 may provide an average fitness grade and score for the pool of applicants. This may serve as an indication as to whether desirable applicants are being identified for the job opening or requisition based on the parameters or metrics for each of the submitted questions provided to applicants.

In addition to providing applicant insights, the job opening detailed summary 504 may provide a tally of the total number of applicants for the job opening or requisition and the total number of applicants that have received a grade or score above a threshold value. For example, as illustrated in FIG. 5, the recruiting automation service, via the service dashboard 502, may present the total number of applicants that have received a grade of “A” from the bot recruiting agent. In some instances, the threshold value may be automatically defined by the recruiting automation service and provided by default. A hiring manager or other entity associated with the job opening or requisition may change this threshold value. For instance, if a hiring manager changes the threshold value from an “A” grade to a “B” grade, the recruiting automation service may update, in real time, the job opening detailed summary 504 to provide the total number of applicants that have received a grade of “B” or better.

The job opening detailed summary 504 may further provide a breakdown of the different sources of applicants for the job opening or requisition. In an embodiment, the recruiting automation service may publish the job opening or requisition on different platforms (e.g., social networking sites, employment sites, etc.), whereby applicants can select the job opening or requisition and be directed to the recruiting automation service to interact with a bot recruiting agent associated with the job opening or requisition. The recruiting automation service may record the source for each applicant and provide statistics regarding these sources via the job opening detailed summary 504. This may provide insights to the hiring manager as to the particular sources that are effective in attracting applicants for a job opening or requisition.

The interface 500 provided via the service dashboard 502 may further include an applicant summary 506. The applicant summary 506 may include similar elements to those included in the graded applicants panel 410 described above in connection with FIG. 4. For instance, for each applicant, the applicant summary 506 may specify the applicant's name, fitness grade and score, the applicant's status, and an option to advance the applicant in the application process for the job opening or requisition. In addition to these elements, the recruiting automation service may provide, for each applicant, links to additional materials that may have been provided by the applicant to the bot recruiting agent. For instance, via the applicant summary 506, the recruiting automation service may provide links corresponding to network locations of an applicant's resume or curriculum vitae, of an applicant's professional website or profile page, of an applicant's contact information, and the like. Using any of these links, a hiring manager may access these additional materials to obtain additional insights about an applicant and determine whether to advance the applicant.

In an embodiment, if the particular job opening or requisition for which applicant grades, provided materials, and metrics are provided is associated with a set or grouping of job openings or requisitions (e.g., the job opening or requisition is assigned a classification that is shared with one or more other existing job openings or requisitions, etc.), the recruiting automation service, through the service dashboard 502, may provide an indication as to whether an applicant has obtained a higher fitness grade and corresponding score for a different job opening or requisition. For example, through the applicant summary 506, the recruiting automation service may indicate whether a particular applicant has obtained a higher fitness grade and corresponding score for a different job opening or requisition that may be associated with the particular job opening or requisition for which a summary is being provided through the service dashboard 502. In some instances, through the applicant summary 506, the recruiting automation service may provide an option to review an applicant's fitness grades and corresponding scores for the other job openings or requisitions that may be associated with the particular job opening or requisition for which applicant grades, provided materials, and metrics are provided. Through selection of this option, the recruiting automation service may provide a hiring manager or other entity associated with a company or organization with insights as a particular applicant's fitness for these other job openings or requisitions and determine whether the applicant may be a better fit or otherwise more qualified for a different, but related, job opening or requisition.

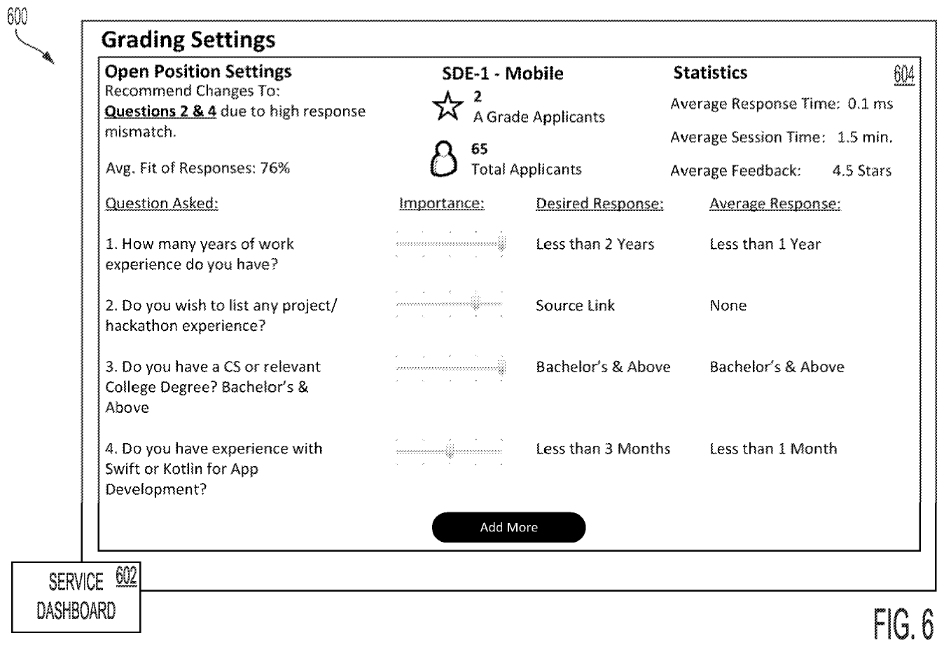

FIG. 6 shows an illustrative example of an interface 600 provided via a service dashboard 602 for reviewing recommendations and adjusting metrics corresponding to questions provided to applicants via a bot recruiting agent for a job opening or requisition in accordance with at least one embodiment. The interface 600 may be updated to provide a hiring manager or other entity associated with the job opening or requisition with recommendations for updating or changing parameters or metrics related to one or more questions submitted to applicants to determine the fitness of these applicants for the job opening or requisition. In an embodiment, the recruiting automation service evaluates the fitness score or grade associated with each submitted question of each applicant to determine whether the average fitness score or grade for each questions satisfies a minimum threshold value. If the average fitness score or grade for a particular question does not satisfy a minimum threshold value, the recruiting automation service may generate a recommendation for modifying the metrics or parameters associated with the particular question. This recommendation may be presented via the interface 600 within a grading settings panel 604.

In an embodiment, the recruiting automation service uses a machine learning algorithm or artificial intelligence to generate recommendations for modifying the parameters or metrics corresponding to different questions submitted to applicants to determine the fitness of these applicants for a job opening or requisition. For instance, the recruiting automation service may provide, as input to the machine learning algorithm or artificial intelligence, the questions submitted by the hiring manager or other entity, the desired responses to these questions, the actual responses to these questions as provided by applicants, and the level of importance of each question as defined by the hiring manager or other entity during creation of the job opening or requisition. The resulting output may specify the recommendations that may be used by the hiring manager or other entity to adjust the importance of each of the submitted questions and/or to change the questions submitted to applicants for the job opening or requisition. As noted above, this machine learning algorithm or artificial intelligence may be trained using supervised training techniques. Further, the machine learning algorithm or artificial intelligence may be evaluated to determine, based on the input sample questions, importance levels, desired responses, and actual responses supplied to the machine learning algorithm or artificial intelligence, whether the machine learning algorithm or artificial intelligence is providing useful recommendations that can be provided to the hiring manager or other entity submitting the job opening or requisition. Based on this evaluation, the machine learning algorithm or artificial intelligence may be modified (e.g., one or more parameters or variables may be updated) to increase the likelihood of the machine learning algorithm or artificial intelligence generating the desired recommendations.

As illustrated in FIG. 6, the recruiting automation service may update the grading settings panel 604 to provide and present the generated recommendations to the hiring manager or other entity that submitted the job opening or requisition. The generated recommendations may indicate what changes may be made to the parameters or metrics associated with one or more questions, as well as a rationale for making these changes. For example, as illustrated in FIG. 6, the recruiting automation service may recommend making changes to two questions due to a high response mismatch amongst applicants.

In addition to providing recommendations to the hiring manager or other entity via the grading settings panel 604, the recruiting automation service may further provide statistics with regard to the performance of the bot recruiting agent associated with the job opening or requisition and any feedback provided by applicants with regard to the performance of the bot recruiting agent. For example, as illustrated in FIG. 6, the recruiting automation service may indicate the average response time of the bot recruiting agent in providing questions and responses to applicants during a communications session. Further, the recruiting automation service may indicate the average session time of a communications session between a bot recruiting agent and applicants. The recruiting automation service may further provide the average feedback score, which may be calculated based on feedback provided by applicants during or after their respective communications sessions with the bot recruiting agent. In an embodiment, the recruiting automation service may use the feedback provided by applicants to modify the bot recruiting agent to improve its performance and to provide an improved experience.

The recruiting automation service may further provide, via the grading settings panel 604, data corresponding to the questions asked to applicants of the job opening or requisition. This data may indicate, for each question, the desired response for the question (as provided or otherwise indicated by a hiring manager or other entity that submitted the job opening or requisition) and the average response provided by applicants. In some instances, for each question, the recruiting automation service may further provide the average fitness score or grade of responses provided by the pool of applicants for the question. This may provide a hiring manager or other entity with context related to any recommendations provided by the recruiting automation service, as well as insight as to areas where the hiring manager or other entity may wish to adjust the level of importance in order to identify desirable applicants for the job opening or requisition.

The recruiting automation service may also provide, via the grading settings panel 604 and for each question, an interactive element that may be used to adjust the level of importance for the submitted question. For example, as illustrated in FIG. 6, for each question asked, the recruiting automation service may provide a slider indicating the level of importance assigned to the question. The initial value or setting of the slider may correspond to the level of importance assigned to the question during creation of the job opening or requisition (as illustrated in FIGS. 2B-2D, for example). In an embodiment, if the hiring manager or other entity interacts with the interactive element for a particular question to change the level of importance of the particular question, the recruiting automation service can dynamically and in real-time update the fitness grade or score of applicant responses to the particular question and present the updated fitness grade or score of each applicant via the interface 600. For instance, if the hiring manager or other entity adjusts the level of importance of a particular question, the recruiting automation service may calculate a new weight for the question and adjust the overall fitness score or grade calculation for the job opening or requisition. Using the adjusted overall fitness score or grade calculation, the recruiting automation service may calculate new overall fitness scores or grades for the pool of applicants and present these new overall fitness scores or grades to the hiring manager or other entity via the service dashboard 602. In an embodiment, the recruiting automation service processes the change to the level of importance for a particular question using the machine learning algorithm or artificial intelligence used to generate recommendations, as described above, to identify any new recommendations for changing parameters or metrics associated with the submitted questions. If there are any new recommendations, these may be presented to the hiring manager or other entity via the grading settings panel 604.

In an embodiment, if the job opening or requisition is associated with a particular set or group of job openings or requisitions (e.g., the job opening or requisition is assigned a classification that is shared with one or more other existing job openings or requisitions, etc.), the recruiting automation service may dynamically, and in real-time, compare the updated fitness grade or score of each applicant for the job opening or requisition to the fitness grades or scores of each applicant for the other job openings or requisitions within the set or group. For example, in addition to dynamically, and in real-time, calculating new overall fitness scores or grades for the pool of applicants for the job opening or requisition as a result of an adjustment to the overall fitness score or grade calculation for the job opening or requisition, the recruiting automation service may update the service dashboard 602 to provide an indication as to whether one or more candidates have a higher fitness score or grade for a different job opening or requisition that may be associated with the particular job opening or requisition. Thus, as a hiring manager or other entity changes the level of importance of a particular question associated with the job opening or requisition, the recruiting automation service may dynamically provide, in real-time, an indication as to whether this change impacts whether an applicant may be better suited for the job opening or requisition or for any of the other job openings or requisitions associated with the particular job opening or requisition.

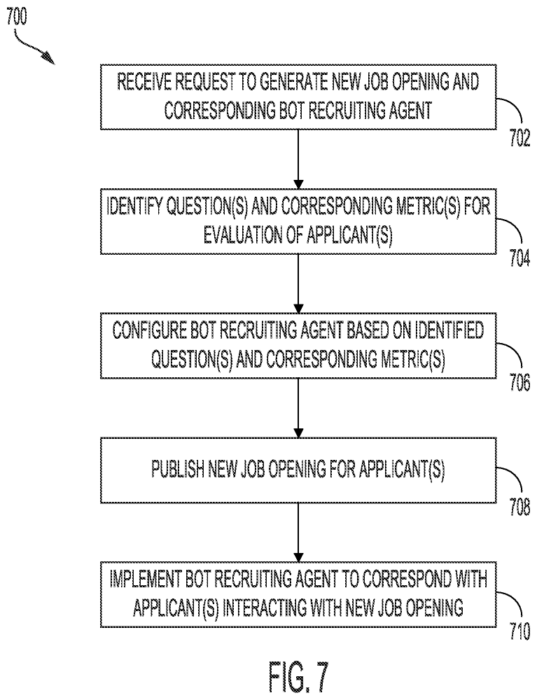

FIG. 7 shows an illustrative example of a process 700 for configuring a bot recruiting agent for a new job opening or requisition in accordance with at least one embodiment. The process 700 may be performed by a recruiting automation service, via a bot creation engine configured to generate and maintain bot recruiting agents for various job openings or requisitions created via the recruiting automation service. At step 702, the recruiting automation service receives a request to generate a new job opening or requisition and a corresponding bot recruiting agent that may be used to interact with applicants to solicit responses that may be used to evaluate these applicants for the job opening or requisition. For instance, a hiring manager or other entity may use a service dashboard provided by the recruiting automation service to configure a new job opening or requisition that may be published via one or more platforms (e.g., websites, etc.). Through the service dashboard, a hiring manager or other entity may define parameters or metrics for configuration of a bot recruiting agent for the new job opening or requisition. For example, the hiring manager or other entity may define the level of importance of each question that is to be submitted to potential applicants. Further, the hiring manager or other entity may define desired answers to the questions that are to be submitted to potential applicants.

At step 704, the recruiting automation service may identify the questions that are to be submitted to potential applicants, as well as any corresponding metrics that may be used to evaluate responses provided by applicants. For instance, the recruiting automation service may determine the level of importance assigned to each submitted question for a job opening or requisition and calculate a corresponding weight to each submitted question. For instance, if the hiring manager indicates that a particular question is of more importance, the recruiting automation service may assign a greater weight to the particular question. Alternatively, if the hiring manager indicates that a particular question is of lesser importance, the recruiting automation service may assign a lesser weight to the particular question. In an embodiment, the weights may be calibrated such that a resulting aggregated score for each applicant falls within a pre-defined range (e.g., 0-100, etc.). In some instances, the recruiting automation service may generate one or more formulae that may be used to automatically calculate an applicant's score or grade for the job opening or requisition based on the responses submitted by the applicant.

At step 706, the recruiting automation service, via a bot creation engine, may configure a bot recruiting agent based on the identified questions and corresponding metrics (e.g., weights, formulae, etc.). For instance, the recruiting automation service may provide the bot creation engine with instructions specifying the questions that are to be asked and the corresponding weights for each of these questions. In some instances, the recruiting automation service may provide the bot creation engine with the one or more formulae that may be used by a bot recruiting agent to automatically calculate an applicant's score or grade for the job opening or requisition based on the responses submitted by the applicant.

At step 708, the recruiting automation service may publish the new job opening or requisition to potential applicants. For instance, the recruiting automation service may publish the job opening or requisition on different platforms (e.g., social networking sites, employment sites, etc.), whereby applicants can select the job opening or requisition and be directed to the recruiting automation service to interact with a bot recruiting agent associated with the job opening or requisition. The recruiting automation service may record the source for each applicant and provide statistics regarding these sources via the job opening detailed summary.

At step 710, the recruiting automation service, via the bot creation engine, may implement the bot recruiting agent to correspond with applicants interacting with the new job opening or requisition. For example, the bot creation engine may associated a bot creation engine with the new job opening or requisition such that, when an applicant interacts with the new job opening or requisition, a communications session is established between the applicant and the bot recruiting agent. Through this communications session, the bot recruiting agent may ask the applicant the questions submitted by the hiring manager or other entity and score any responses provided by the applicant to these questions according to the weights and/or formulae provided by the recruiting automation service.

It should be noted that the process 700 may be performed for a plurality of job openings for which a single bot recruiting agent may be configured and implemented to interact with applicants for any of the job openings of the plurality of job openings. For example, a hiring manager or other entity may utilize a service dashboard provided by the recruiting automation service to configure a plurality of new job openings or requisitions that may be published via one or more platforms. This plurality of new job openings or requisitions may be related (e.g., same business unit, same organization, same skill code, etc.) such that an applicant that may be qualified for at least one new job opening or requisition within the plurality may also be qualified for other job openings or requisitions within the plurality. In some instances, the hiring manager or other entity may configure a new job opening or requisition and indicate that the new job opening or requisition is related to a plurality of existing job openings or requisitions previously submitted to the recruiting automation service.

In an embodiment, and as described above, if a hiring manager or other entity configures a new job opening or requisition, the recruiting automation service, the recruiting automation service can use a machine learning algorithm or artificial intelligence to automatically recommend, to the hiring manager, possible groupings for the new job opening or requisition. The machine learning algorithm or artificial intelligence may be trained using unsupervised learning techniques. The output of the machine learning algorithm or artificial intelligence may be provided to the hiring manager as a recommendation for grouping different job openings or requisitions together such that a single bot recruiting agent may be implemented to interact with applicants for any of these job openings or requisitions and provide, for the applicant, a grade or score for each of the job openings or requisitions within the group.

If the hiring manager designates a new job opening or requisition as being part of a plurality of job openings or requisitions, the recruiting automation service may automatically identify the questions that are to be submitted to potential applicants from the plurality of job openings or requisitions. The different job openings or requisitions of the plurality may be associated with the same set of questions that may be used to determine an applicant's fitness for any of these different job openings or requisitions. Accordingly, if the new job opening or requisition is identified as being part of this plurality of job openings or requisitions, the recruiting automation service may automatically associate this set of questions with the new job opening or requisition. However, for the new job opening or requisition, the hiring manager may define a set of metrics that may be used to evaluate applicant responses to the set of questions presented for the new job opening or requisition. Thus, each job opening or requisition within the plurality may have a different grading schema.

The recruiting automation service, via the bot creation engine, may configure a single bot recruiting agent to correspond with applicants interacting with any job opening or requisition of the plurality of job openings or requisitions, including any new job opening or requisition added to the plurality. The recruiting automation service may configure the single bot recruiting agent to ask applicants the same questions for any of the job openings or requisitions of the plurality. However, the single bot recruiting agent may be configured to identify and apply the appropriate grading schema corresponding to the job opening or requisition that an applicant has selected and is applying to. For instance, when an applicant selects a particular job opening or requisition, and the communications session is established between the applicant and the bot recruiting agent, the bot recruiting agent may automatically identify the applicable grading schema for the particular job opening or application. The bot recruiting agent may score any responses provided by the applicant according to the grading schema for the particular job opening or requisition. Additionally, because the job opening or requisition may be related to other existing job openings or requisitions, the bot recruiting agent may dynamically, and automatically, obtain the grading schema for each of the other existing job openings or requisitions and score the applicant's responses according to grading schema for each of the other existing job openings or requisitions. This may result in a plurality of applicant scores or grades for each of the job openings or requisitions of the plurality of job openings or requisitions.

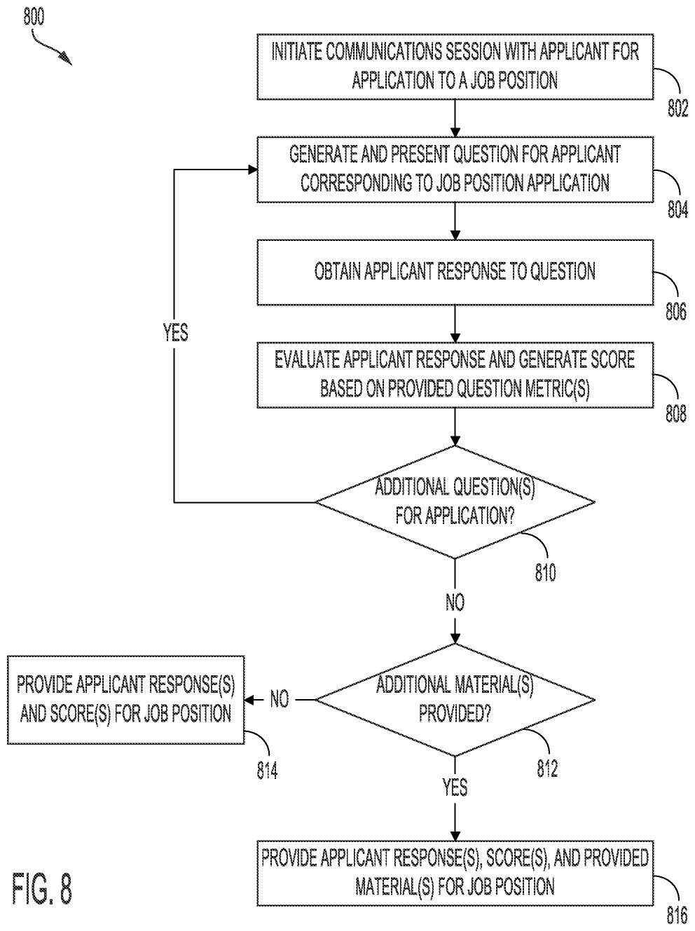

FIG. 8 shows an illustrative example of a process 800 for grading responses provided by an applicant based on interaction with the applicant via a communications session and provided the grades and other provided materials for an applicant in accordance with at least one embodiment. The process 800 may be performed by a bot recruiting agent corresponding to a job opening or requisition made available to applicants. At step 802, the bot recruiting agent may initiate a communications session with an applicant for application to a job opening or requisition. The communications session may be established as an instant messaging or other form of chat messaging, through which the applicant and the bot recruiting agent may exchange text-based messages over the communications session. Alternatively, the communications session established by the bot recruiting agent between the applicant and the bot recruiting agent may be implemented subject to a Rich Communication Services (RCS) protocol or other multimedia protocol through which the applicant and the bot recruiting agent may exchange rich messages or other in-call multimedia. The communications session may be established upon detection of applicant interaction with the job opening or requisition via one or more platforms, as described above. Alternatively, the applicant may submit a request to establish the communications session in order to apply for the job opening or requisition.

At step 804, the bot recruiting agent may generate and present the first question for the applicant corresponding to the job opening or requisition. As noted above, the bot recruiting agent may NLP or other artificial intelligence to query the applicant for responses that can be used to determine the applicant's fitness (e.g., grade, score, etc.) for the particular job opening or requisition. The bot recruiting agent may identify parameters of a question that is to be asked, as defined by a recruiting automation service, and use NLP to craft the question using a natural language. The question may be presented to the applicant via the communications session, through which the applicant may be prompted to provide a response to the question.

At step 806, the bot recruiting agent may obtain a response to the question from the applicant via the communications session. The response may be in the form a text-based communication or message transmitted over the communications session. Alternatively, the applicant may provide additional materials (e.g., resumes, etc.) from which the response may be obtained. For instance, if an applicant provides a resume in response to a particular question, the bot recruiting agent may process the resume and extract any information that may serve as a response to the submitted question. In an embodiment, the bot recruiting agent provides a limited period of time for providing a response to the submitted question. If a response is not obtained within this period of time, the bot recruiting agent may perform one or more operations. For instance, the bot recruiting agent may repeat the question and provide the applicant another period of time to provide a response. If the applicant fails to provide a response, the bot recruiting agent may record a null response to the question for the applicant. In some instances, if a response is not obtained after a repeated attempt, the bot recruiting agent may terminate the communications session.

At step 808, if the applicant provides a response to the submitted question, the bot recruiting agent may evaluate the response and generate a score or grade based on the parameters or metrics corresponding to the question. For instance, the bot recruiting agent may compare the response to a particular question to the desired response provided by the hiring manager or other entity during creation of the new job opening or requisition. Based on the proximity of the response provided by an applicant to the desired response for a particular question, the bot recruiting agent may determine a fitness score or grade for the response. In some instances, the fitness score or grade for the response may further be determined based on the weight assigned to the question by the recruiting automation service. As noted above, this weight may be determined based on the level of importance ascribed to the question by a hiring manager or other entity that submitted the job opening or requisition.

At step 810, the bot recruiting agent may determine whether there are additional questions that are to be submitted to the applicant for its application to the job opening or requisition. If there are any additional questions, the bot recruiting agent may select, generate, and present another question to the applicant via the communications session, thereby repeating steps 804-808 of the process 800. Once the bot recruiting agent has obtained responses to each question associated with the job opening or requisition, the bot recruiting agent, at step 812, may determine whether the applicant has provided additional materials to supplement its application to the job opening or requisition. For instance, via the communications session, an applicant may provide its resume or curriculum vitae, any hyperlinks to professional profiles or websites, any sample works prepared by the applicant, and the like.

If the applicant has not provided any additional materials to supplement its application to the job opening or requisition, the bot recruiting agent, at step 814, may provide the applicant's responses and corresponding fitness grades or scores to the recruiting automation service for presentation to the hiring manager or other entity associated with the job opening or requisition. Alternatively, if the applicant has provided additional materials in addition to its responses to the submitted questions, the bot recruiting agent, at step 816, may provide these additional materials in addition to the applicant's responses and corresponding fitness grades or scores to the recruiting automation service. This may cause the recruiting automation service to make these additional materials available to the hiring manager or other entity associated with the job opening or requisition via a service dashboard of the recruiting automation service.

It should be noted that the process 800 may include additional and/or alternative steps. For example, if the bot recruiting agent is implemented to communicate with applicants for various job openings or requisitions rather than a single job position or requisition, the bot recruiting agent may apply the parameters or metrics corresponding to the question and to the other job openings or requisitions of the various job openings or requisitions. As noted above, a job opening or requisition may be associated with a plurality of other job openings or requisitions based on one or more factors. For instance, a plurality of j ob openings or requisitions may share a classification whereby each job opening or requisition is tied to a particular business unit, location, organization, skill code, and/or other attribute. As an illustrative example, a plurality of job openings or requisitions may correspond to openings for electrical engineers having different levels of technical experience at a particular site. Accordingly, while an applicant may apply to a job opening or requisition corresponding to a senior electrical engineer position at the particular site, the applicant may be more suited to a more junior electrical engineer position for which a different job opening or requisition has been created. However, these different job openings or requisitions may be related as they are both for electrical engineers at the particular site.

As an applicant provides its responses to the various questions posed by the bot recruiting agent over the communications session for the particular job opening or requisition, the bot recruiting agent may dynamically, and automatically, generate scores or grades according to the various parameters or metrics corresponding to the question as defined for each of the job openings or requisitions (including the job opening or requisition the applicant is applying to) that form the plurality of job openings or requisitions. The bot recruiting agent may provide the applicant's responses and corresponding fitness grades or scores to the recruiting automation service for presentation to the hiring manager or other entity associated with the job opening or requisition. These fitness grades or scores may include the fitness grades or scores corresponding to the job opening or requisition that the applicant directly applied to, as well as any fitness grades or scores corresponding to the other job openings or requisitions that are associated with the job opening or requisition that the applicant directly applied to. This may allow the hiring manager or other entity to readily determine whether an applicant is best suited for the job opening or requisition that they directly applied to or for any of the other job openings or requisitions that are associated with the job opening or requisition that the applicant directly applied to.

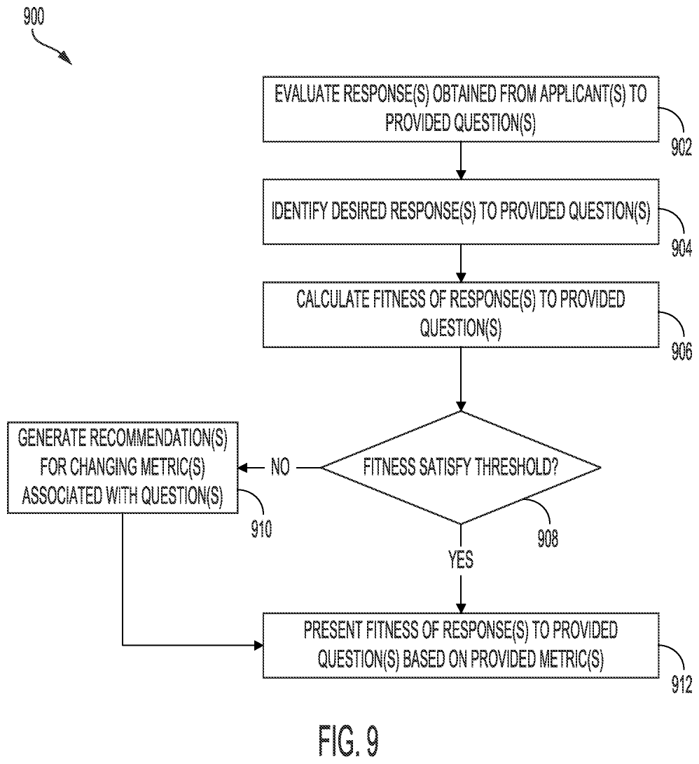

FIG. 9 shows an illustrative example of a process 900 for generating recommendations for changing metrics associated with questions provided to applicants based on fitness of previously provided responses from applicants in accordance with at least one embodiment. The process 900 may be performed by the recruiting automation service, which may present fitness scores and/or grades for different applicants of a job opening or requisition via a service dashboard. At step 902, the recruiting automation agent may evaluate any obtained responses from applicants to questions submitted to these applicants by a bot recruiting agent associated with a job opening or requisition. For instance, the recruiting automation service may determine whether provided responses are, indeed, responsive to the corresponding questions (e.g., the responses are relevant to the questions asked). This may be used to identify actual applicants for the job opening or requisition and eliminate any other entities that may have interacted with the bot recruiting agent for illegitimate means (e.g., spam, prank, etc.).

At step 904, the recruiting automation service may identify the desired responses to the provided questions. As noted above, a hiring manager, via a service dashboard provided by the recruiting automation service, may define desired responses to submitted questions. For example, via the service dashboard, a hiring manager may indicate that an applicant is preferred to have over two years of work experience. These desired responses may be stored in association with the job opening or requisition within a data store of the recruiting automation service. Thus, when responses are obtained from applicants, the recruiting automation service may access this data store to retrieve the desired responses to the questions provided to these applicants.

At step 906, the recruiting automation service may calculate the fitness score and/or grade of responses to the provided questions for each applicant. As noted above, a hiring manager or other entity may assign a particular weight to each question that is to be provided to an applicant during a communications session with a bot recruiting agent for the job opening or requisition. These weights and the responses provided by the applicant may be used to calculate an aggregated fitness grade or other score of the applicant. This calculation may be based on the degree of similarity between the applicant's response to each question and the desired response provided by the hiring manager or other entity for the question. For example, if a hiring manager or other entity has indicated that a desired candidate for a job opening or requisition is to have at least two years of work experience, a higher score may be assigned if the applicant has indicated that it has at least two years of work experience, with the score increasing in proportion to the amount of work experience exceeding two years' worth up to a maximum limit for the particular question and according to the assigned weight.

It should be noted that steps 902-906 may be performed by a bot recruiting agent on behalf of the recruiting automation service. As noted above, a bot recruiting agent may process the responses provided by an applicant, as well as any additional materials provided by the applicant, to calculate a fitness grade or other score of the applicant for the job opening or requisition. This calculation may be performed based on the corresponding weights for each of these questions. In some instances, the recruiting automation service may provide the bot creation engine with one or more formulae that may be used by a bot recruiting agent to automatically calculate an applicant's score or grade for the job opening or requisition based on the responses submitted by the applicant.

At step 908, the recruiting automation service may determine whether the average fitness grade or score for the pool of applicants in aggregate and for each question satisfies a threshold value. If the average fitness score or grade for a particular question does not satisfy a minimum threshold value, the recruiting automation service may, at step 910, generate a recommendation for modifying the metrics or parameters associated with the particular question. For example, as noted above, the recruiting automation service may use a machine learning algorithm or artificial intelligence to generate recommendations for modifying the parameters or metrics corresponding to different questions submitted to applicants to determine the fitness of these applicants for a job opening or requisition. For instance, the recruiting automation service may provide, as input to the machine learning algorithm or artificial intelligence, the questions submitted by the hiring manager or other entity, the desired responses to these questions, the actual responses to these questions as provided by applicants, and the level of importance of each question as defined by the hiring manager or other entity during creation of the job opening or requisition. The resulting output may specify the recommendations that may be used by the hiring manager or other entity to adjust the importance of each of the submitted questions and/or to change the questions submitted to applicants for the job opening or requisition.

If the recruiting automation service determines that the responses to the submitted questions satisfy their respective fitness thresholds or recommendations have been generated for changing metrics associated with these questions, the recruiting automation service, at step 912, may present the fitness of the applicant responses to the submitted questions based on the metrics or parameters for each submitted question. For instance, via a service dashboard, the recruiting automation service may present applicant fitness scores for the job opening or requisition. Further, the recruiting automation service may present the average fitness score or grade for the pool of applicants in aggregate and for each individual question. This may allow a hiring manager or other entity to evaluate the fitness of each applicant and determine whether to advance an applicant for further review. Additionally, the hiring manager or other entity may adjust the metrics or parameters associated with each question to cause the recruiting automation service to dynamically and in real-time adjust the fitness scores or grades for the pool of applicants.

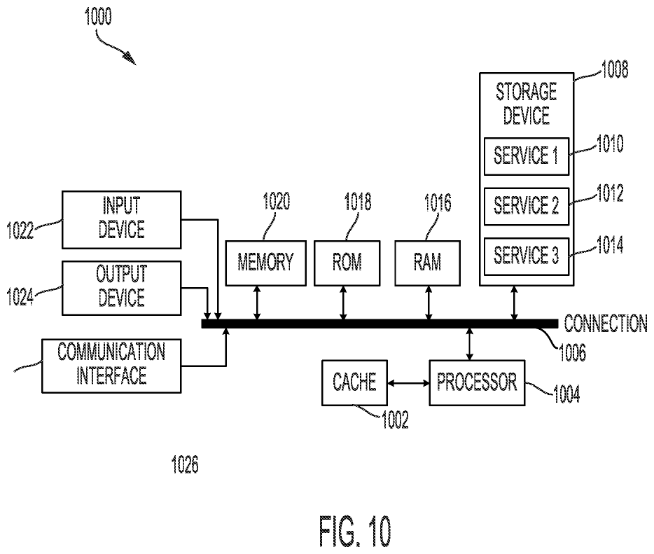

FIG. 10 illustrates a computing system architecture 1000 including various components in electrical communication with each other using a connection 1006, such as a bus, in accordance with some implementations. Example system architecture 1000 includes a processing unit (CPU or processor) 1004 and a system connection 1006 that couples various system components including the system memory 1020, such as ROM 1018 and RAM 1016, to the processor 1004. The system architecture 1000 can include a cache 1002 of high-speed memory connected directly with, in close proximity to, or integrated as part of the processor 1004. The system architecture 1000 can copy data from the memory 1020 and/or the storage device 1008 to the cache 1002 for quick access by the processor 1004. In this way, the cache can provide a performance boost that avoids processor 1004 delays while waiting for data. These and other modules can control or be configured to control the processor 1004 to perform various actions.

Other system memory 1020 may be available for use as well. The memory 1020 can include multiple different types of memory with different performance characteristics. The processor 1004 can include any general purpose processor and a hardware or software service, such as service 1 1010, service 2 1012, and service 3 1014 stored in storage device 1008, configured to control the processor 1004 as well as a special-purpose processor where software instructions are incorporated into the actual processor design. The processor 1004 may be a completely self-contained computing system, containing multiple cores or processors, a bus, memory controller, cache, etc. A multi-core processor may be symmetric or asymmetric.

To enable user interaction with the computing system architecture 1000, an input device 1022 can represent any number of input mechanisms, such as a microphone for speech, a touch-sensitive screen for gesture or graphical input, keyboard, mouse, motion input, speech and so forth. An output device 1024 can also be one or more of a number of output mechanisms known to those of skill in the art. In some instances, multimodal systems can enable a user to provide multiple types of input to communicate with the computing system architecture 1000. The communications interface 1026 can generally govern and manage the user input and system output. There is no restriction on operating on any particular hardware arrangement and therefore the basic features here may easily be substituted for improved hardware or firmware arrangements as they are developed.

Storage device 1008 is a non-volatile memory and can be a hard disk or other types of computer readable media which can store data that are accessible by a computer, such as magnetic cassettes, flash memory cards, solid state memory devices, digital versatile disks, cartridges, RAMs 1016, ROM 1018, and hybrids thereof.

The storage device 1008 can include services 1010, 1012, 1014 for controlling the processor 1004. Other hardware or software modules are contemplated. The storage device 1008 can be connected to the system connection 1006. In one aspect, a hardware module that performs a particular function can include the software component stored in a computer-readable medium in connection with the necessary hardware components, such as the processor 1004, connection 1006, output device 1024, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving a requisition, wherein the requisition includes a set of questions to be presented to one or more applicants, and wherein the set of questions correspond to a set of metrics for evaluating responses to the set of questions;
generating an automated bot based on the requisition, wherein the automated bot is generated to communicate with the one or more applicants over a communications session;
presenting the set of questions using the automated bot;
receiving one or more responses to the set of questions;
automatically calculating a fitness of the one or more responses, wherein the one or more responses correspond to the one or more applicants, and wherein the fitness of the one or more responses is calculated based on desired responses to the set of questions and the set of metrics;
determining a fitness of the one or more applicants based on the fitness of the one or more responses; and
generating recommendations for modifying the set of metrics based on the fitness of the one or more responses.

2. The computer-implemented method of claim 1, further comprising:
detecting a change to the set of metrics;
dynamically generating a new fitness of the one or more responses and a new fitness of the one or more applicants based on the change to the set of metrics; and
generating a new recommendation for modifying the set of metrics based on the new fitness of the one or more responses.

3. The computer-implemented method of claim 1, further comprising using the fitness of the one or more responses, the one or more responses, and the fitness of the one or more applicants as input to a machine learning algorithm, wherein an output of the machine learning algorithm includes the recommendations.

4. The computer-implemented method of claim 1, further comprising:
identifying other requisitions for an applicant, wherein the other requisitions are identified based on responses to the set of questions provided by the applicant to the automated bot; and
presenting the other requisitions.

5. The computer-implemented method of claim 1, further comprising:
receiving additional materials corresponding to an applicant to the requisition; and
evaluating the additional materials to automatically obtain applicant responses to a subset of the set of questions.

6. The computer-implemented method of claim 1, wherein the recommendations for modifying the set of metrics are generated based on a determination as to whether the fitness of the one or more responses satisfies a threshold corresponding to the requisition.

7. The computer-implemented method of claim 1, wherein:
the set of metrics correspond to the desired responses to the set of questions; and
the fitness of the one or more responses is calculated based on proximity of the one or more responses to the desired responses.

8. A system, comprising:
one or more processors; and
memory storing thereon instructions that, as a result of being executed by the one or more processors, cause the system to:
receive a requisition, wherein the requisition includes a set of questions to be presented to one or more applicants, and wherein the set of questions correspond to a set of metrics for evaluating responses to the set of questions;
generate an automated bot based on the requisition, wherein the automated bot is generated to communicate with the one or more applicants over a communications session;
present the set of questions using the automated bot;
receive one or more responses to the set of questions;
automatically calculate a fitness of the one or more responses, wherein the one or more responses correspond to the one or more applicants, and wherein the fitness of the one or more responses is calculated based on desired responses to the set of questions and the set of metrics;
determine a fitness of the one or more applicants based on the fitness of the one or more responses; and
generate recommendations for modifying the set of metrics based on the fitness of the one or more responses.

9. The system of claim 8, wherein the instructions further cause the system to:
detect a change to the set of metrics;
dynamically generate a new fitness of the one or more responses and a new fitness of the one or more applicants based on the change to the set of metrics; and
generate a new recommendation for modifying the set of metrics based on the new fitness of the one or more responses.

10. The system of claim 8, wherein the instructions that cause the system to generate the recommendations further cause the system to use the fitness of the one or more responses, the one or more responses, and the fitness of the one or more applicants as input to a machine learning algorithm, wherein an output of the machine learning algorithm includes the recommendations.

11. The system of claim 8, wherein the instructions further cause the system to:
identify other requisitions for an applicant, wherein the other requisitions are identified based on responses to the set of questions provided by the applicant to the automated bot; and
present the other requisitions.

12. The system of claim 8, wherein the instructions further cause the system to
receive additional materials corresponding to an applicant to the requisition; and
evaluate the additional materials to automatically obtain applicant responses to a subset of the set of questions.

13. The system of claim 8, wherein the recommendations for modifying the set of metrics are generated based on a determination as to whether the fitness of the one or more responses satisfies a threshold corresponding to the requisition.

14. The system of claim 8, wherein:
the set of metrics correspond to the desired responses to the set of questions; and
the fitness of the one or more responses is calculated based on proximity of the one or more responses to the desired responses.

15. A non-transitory, computer-readable storage medium storing thereon executable instructions that, as a result of being executed by one or more processors of a computer system, cause the computer system to:
receive a requisition, wherein the requisition includes a set of questions to be presented to one or more applicants, and wherein the set of questions correspond to a set of metrics for evaluating responses to the set of questions;
generate an automated bot based on the requisition, wherein the automated bot is generated to communicate with the one or more applicants over a communications session;
present the set of questions using the automated bot;
receive one or more responses to the set of questions;
automatically calculate a fitness of the one or more responses, wherein the one or more responses correspond to the one or more applicants, and wherein the fitness of the one or more responses is calculated based on desired responses to the set of questions and the set of metrics;
determine a fitness of the one or more applicants based on the fitness of the one or more responses; and
generate recommendations for modifying the set of metrics based on the fitness of the one or more responses.

16. The non-transitory, computer-readable medium of claim 15, wherein the executable instructions further cause the computer system to:
detect a change to the set of metrics;
dynamically generate a new fitness of the one or more responses and a new fitness of the one or more applicants based on the change to the set of metrics; and
generate a new recommendation for modifying the set of metrics based on the new fitness of the one or more responses.

17. The non-transitory, computer-readable medium of claim 15, wherein the executable instructions that cause the computer system to generate the recommendations further cause the computer system to use the fitness of the one or more responses, the one or more responses, and the fitness of the one or more applicants as input to a machine learning algorithm, wherein an output of the machine learning algorithm includes the recommendations.

18. The non-transitory, computer-readable medium of claim 15, wherein the executable instructions further cause the computer system to:
identify other requisitions for an applicant, wherein the other requisitions are identified based on responses to the set of questions provided by the applicant to the automated bot; and
present the other requisitions.

19. The non-transitory, computer-readable medium of claim 15, wherein the executable instructions further cause the computer system to:
receive additional materials corresponding to an applicant to the requisition; and
evaluate the additional materials to automatically obtain applicant responses to a subset of the set of questions.

20. The non-transitory, computer-readable medium of claim 15, wherein the recommendations for modifying the set of metrics are generated based on a determination as to whether the fitness of the one or more responses satisfies a threshold corresponding to the requisition.

21. The non-transitory, computer-readable medium of claim 15, wherein:
the set of metrics correspond to the desired responses to the set of questions; and
the fitness of the one or more responses is calculated based on proximity of the one or more responses to the desired responses.
